(19) United States
(12) Patent Application Publication
(10) Pub. No.: US 2013/0103577 A1
(43) Pub. Date: Apr. 25, 2013

(54) SYSTEMS AND METHODS FOR OPTIMIZING FINANCIAL TRANSACTIONS

(71) Applicant: Fiserv, Inc., Brookfield, WI (US)

(72) Inventors: Mary Elizabeth Lawson, Westerville, OH (US); Andrew Montgomery Litt, Plain City, OH (US); Christopher Dean Stroud, Columbus, OH (US); Mark T. Harris, Westerville, OH (US)

(73) Assignee: FISERV, INC., Brookfield, WI (US)

(21) Appl. No.: 13/658,615

(22) Filed: Oct. 23, 2012

Related U.S. Application Data
(60) Provisional application No. 61/550,643, filed on Oct. 24, 2011.

(51) Int. Cl. G06Q 20/38

(52) U.S. Cl. 705/39

(57) ABSTRACT

Systems, methods and computer-readable media for optimizing financial transactions are disclosed. Candidate source and target financial accounts may be respectively identified based on source and target identifiers. Respective candidate source payment networks configured to access each candidate source financial account and respective candidate target payment networks configured to access each candidate target financial account may be identified. Based at least in part on an analysis of one or more rules, a set of transaction options may be generated. Each transaction option may be associated with a particular combination of source and target financial accounts and payment networks and may further be associated with one or more transaction characteristics. Respective transaction options information associated with one or more of the transaction options may be transmitted and potentially presented to a financial transaction requestor. The requestor may be provided with a capability to indicate a selection of a transaction option for processing of a financial transaction. In other scenarios, an analysis of a set of transaction options may be performed based on a complete financial transaction request that includes a transaction amount. An indication of whether the financial transaction is executable may be transmitted, potentially for presentation to a financial transaction requestor.

### CROSS-REFERENCE TO RELATED APPLICATION(S)

This application claims the benefit of U.S. Provisional Application No. 61/550,643, filed Oct. 24, 2011.

### BACKGROUND

Account holders or other financial transaction requestors may utilize a variety of types of client applications to initiate financial transactions. A financial transaction requestor may specify transaction details including information that identifies financial accounts to be debited or credited as part of the financial transaction and/or information that identifies parties to the transaction (e.g., a payor and a payee) as well as information that indicates an amount of funds to be exchanged as part of the financial transaction.

### BRIEF DESCRIPTION OF THE DRAWINGS

The detailed description is set forth with reference to the accompanying drawings. The use of the same reference numerals indicates similar or identical elements; however, different reference numerals may be used to indicate similar or identical elements as well. Various embodiments may utilize elements and/or components other than those illustrated in the drawings and some elements and/or components may not be present in various embodiments. It should be appreciated that while singular terminology may be used to describe a component or element, a plural number of such components or elements are also within the scope of the disclosure.

FIG. 1 schematically depicts an illustrative networked architecture configured to support financial transaction options optimization processing in accordance with one or more embodiments of the disclosure.

FIG. 2 schematically depicts an illustrative device configured to support financial transaction options optimization processing in accordance one or more embodiments of the disclosure.

FIG. 3 is a process flow diagram depicting an illustrative method for identifying candidate source and target financial accounts and associated candidate payment networks and performing transaction options optimization processing in accordance with one or more embodiments of the disclosure.

FIG. 4 is a process flow diagram depicting an illustrative method for performing transaction options optimization processing in accordance with one or more embodiments of the disclosure.

FIG. 5 is a process flow diagram depicting an illustrative method for generating and transmitting a set of transaction options identified based on transaction options optimization processing, receiving an indication of a selection of a transaction option, and performing additional processing based on the selected transaction option in accordance with one or more embodiments of the disclosure.

FIG. 6 is a process flow diagram depicting an illustrative method for identifying candidate source and target financial accounts and associated candidate payment networks and performing transaction options optimization processing in accordance with one or more alternative embodiments of the disclosure.

FIG. 7 is a process flow diagram depicting an illustrative method for identifying whether a financial transaction is executable and transmitting information pertaining thereto in accordance with one or more embodiments of the disclosure.

FIG. 8 is a schematic diagram depicting an illustrative use case in accordance with one or more embodiments of the disclosure.

FIG. 9 is a schematic diagram depicting another illustrative use case in accordance with one or more additional embodiments of the disclosure.

### DETAILED DESCRIPTION

### Overview

Embodiments of the disclosure relate to systems, methods, and computer-readable media for performing financial transaction options optimization processing to identify a set of potential transaction options for processing a financial transaction. Each transaction option that is identified may be associated with a candidate source financial account to be debited as part of the financial transaction, a candidate target financial account to be credited as part of the financial transaction, a candidate source payment network for accessing the source financial account, a candidate target payment network for accessing the target financial account, and one or more transaction characteristics. The transaction characteristic(s) may relate to one or more parameters including, but not limited to, a speed of the financial transaction (e.g., “immediate” or “same day,” “next day,” another payment issuance or payment posting date in the future, etc.), a cost associated with processing the financial transaction, a maximum allowable amount of funds that may be transferred, a minimum amount of funds that must be transferred, and so forth.

A service provider system may be provided that includes a transaction options optimization subsystem and a payment networks hub subsystem. The service provider system may be configured to communicate and interact with any number of client applications that may support a variety of types of financial transactions. In one or more illustrative embodiments, the service provider system may be configured to receive information from a client application that identifies parties to a financial transaction. The information may optionally be provided by a financial transaction requestor and may be received as part of an incomplete financial transaction request that does not include (at this stage) an indication of a transaction amount.

In one or more illustrative embodiments, the information received by the service provider system on behalf of a financial transaction requestor may include a source identifier associated with a first account holder (e.g., an account holder associated with a financial account to be debited as part of a financial transaction) and a target identifier associated with a second account holder (e.g., an account holder associated with a financial account to be credited as part of a financial transaction). The first account holder and the second account holder may also be referred to herein as a source account holder and target account holder, respectively. The source identifier and/or the target identifier may be any suitable identifier for identifying an associated account holder and/or an associated financial account including, but not limited to, a contact identifier (e.g., an electronic mail address, a telephone number, etc.), an entity identifier (e.g., a username associated with the service provider system, a username associated with a financial institution, a government identifier, an identifier designated by a user or the service provider system to identify a payor or a payee, a social networking identifier, etc.), a financial account identifier, and so forth.

The service provider system may also optionally receive preference information that indicates a priority or preference with respect to one or more of: a type of financial account (source and/or target), a payment network (source and/or target), a transaction speed, a transaction cost, and so forth. The preference information may reflect a preference or prioritization specified by a financial transaction requestor (e.g., an account holder), a financial institution, a sponsor, and so forth. The term “sponsor” may be used herein to refer to an entity provides a registered user with access to functionality and/or services provided by a service provider.

The service provider system may identify one or more candidate source financial accounts and one or more candidate target financial accounts based at least in part on the received source identifier and target identifier, respectively. If preference information is received, the service provider system may optionally utilize the preference information to identify candidate source and target financial accounts and/or to order the identified accounts based on the preference information. The service provider system may access one or more datastores storing registry information and may perform a lookup to identify candidate financial accounts associated with the received identifiers. Alternatively, or additionally, the service provider system may submit a request to a service (e.g., a web service) to identify candidate financial accounts based on the received identifiers and, optionally, received preference information.

In certain embodiments, if at least one source financial account is not identified based on the source identifier, it may be assumed that the source account holder is not a registered user of the service provider system. Similarly, if at least one target financial account is not identified based on the target identifier, it may be assumed that the target account holder is not a registered user of the service provider system. Under such scenarios, an invitation to become a registered user of the service provider system may be generated and transmitted to the appropriate entity (e.g., the source account holder or the target account holder). The source identifier or target identifier may be used to identify a corresponding notification identifier, and the invitation to register may be transmitted to the notification identifier. In certain embodiments, the source or target identifier may itself serve as a notification identifier such as when the source or target identifier is a contact identifier such as an electronic mail address, a telephone number, and so forth.

Upon identification of candidate source and target financial accounts, the service provider system may identify, for each candidate source financial account, a respective set of one or more candidate source payment networks for accessing the candidate source financial account. The service provider system may leverage one or more local and/or remote datastores, a service (e.g., a web service), an Application Programming Interface (API), or the like to determine whether the source financial account is accessible through a particular payment network. A respective set of one or more candidate target payment networks may be identified for each candidate target financial account in a similar manner.

Upon identification of a respective set of payment networks for accessing each source financial account and each target financial account, the service provider system may initiate transaction options optimization processing. However, prior to initiating transaction options optimization processing, various forms of risk processing may be performed. In various embodiments, the risk processing may form part of the transaction options optimization processing. The risk processing may be associated with one or both of the source account holder or the target account holder or with a financial transaction requestor who is different from the source and target account holders. The risk processing may include, but is not limited to, identity verification processing, account access authorization processing, fraud mitigation processing, credit-worthiness determination processing, and so forth. In certain embodiments, if the risk processing is successful, the service provider system may initiate the transaction options optimization processing. In other embodiments, the risk processing may form part of the transaction options optimization processing and if the risk processing is successful, further transaction options optimization processing may be performed. The transaction options optimization processing may iterate through each candidate source payment network identified for each candidate source financial account to determine whether one or more network rules associated with the candidate source payment network are satisfied, and thus, whether the candidate source payment network is eligible for use in connection with the candidate source financial account. If at least one of the network rules is not satisfied, the associated candidate source payment network may be eliminated from consideration as an eligible payment network. Similar processing may be performed with respect to each candidate target payment network identified for each candidate target financial account.

If it is determined that respective network rule(s) associated with at least one candidate payment network identified for a particular financial account are satisfied, one or more account rules associated with the financial account may be identified and assessed to determine whether the financial account is eligible for use in connection with a financial transaction involving entities identified by the source and target identifiers. If all associated account rules are satisfied, the candidate financial account may remain eligible for use. The above-described processing may be performed in connection with each candidate source financial account and each candidate target financial account to determine a set of transaction options for financial transactions involving entities identified by the source and target identifiers.

Each transaction option may be associated with particular source and target financial accounts and particular source and target payment networks for accessing the source and target financial accounts, respectively. In addition, each transaction option may be further associated with a respective set of one or more transaction characteristics that relate to one or more parameters associated with a financial transaction such as, for example, a speed of the financial transaction, a cost of the financial transaction, and so forth.

Transaction options information associated with the set of transaction options may be transmitted by the service provider system, potentially for presentation to a financial transaction requestor. For example, the financial transaction requestor may be presented with the transaction options information via a client application interface. For each transaction option, the corresponding transaction options information presented to the requestor may represent an abstraction of the underlying transaction option details. For example, the requestor may be provided with an indication of a speed and/or a cost associated with the transaction option in an abstract form (e.g., “normal,” “fast/expedited,” “immediate/same-day,” “high transfer amount,” each optionally with associated fees). In certain embodiments, other transaction option details (e.g., the source and target financial accounts, the source and target payment networks, etc.) may be hidden from the requestor. In other embodiments, the transaction options information presented to the requestor may include information indicating all or some of the transaction option details associated with a transaction option. It should be appreciated that the above examples of abstracted information that may be presented to a requestor are merely illustrative and not exhaustive.

The requestor may be provided with functionality that allows the requestor to select a particular transaction option for conducting a financial transaction. The requestor may indicate a transaction amount and, optionally, a desired transaction issuance date or a transaction posting date in connection with selection of a particular transaction option. As used herein, the phrase “transaction posting date” may refer to a date on which the funds exchanged as part of the financial transaction are posted to a target financial account. The service provider system may receive on behalf of the financial transaction requestor an indication of the selected transaction option, an indication of the transaction amount, and, optionally, an indication of a desired transaction issuance date or transaction posting date. The service provider system may then proceed to initiate risk processing or transaction authorization processing as appropriate based on the source financial account and source payment network associated with the selected transaction option. The risk processing or transaction authorization processing may include, but is not limited to, credit account authorization processing, real-time debit processing, “good funds” processing, risk analysis with respect to the financial transaction, and so forth. In certain embodiments, the risk processing may also include processing relating to the financial transaction requestor if such processing is not performed prior to initiation of the transaction options optimization processing. Risk processing relating to the financial transaction requestor may include processing to confirm an identity of the requestor and/or whether the requestor is authorized to initiate the financial transaction, processing to assess past behavioral characteristics associated with the requestor with respect to financial transactions, processing to ensure that behavioral characteristics associated with the requestor with respect to the current financial transaction request are consistent with previous behavior patterns, and so forth.

The service provider system may transmit for presentation to the financial transaction requestor an indication that the financial transaction has been approved or declined based on results of the risk processing or transaction authorization processing. If the financial transaction has been approved for the selected transaction option, a client application via which the financial transaction request was submitted may proceed to submit, to the service provider system, a request to originate a debit and/or a credit associated with the financial transaction. In other embodiments, the service provider system may originate the debit and/or credit independently of a client application if the risk processing or transaction authorization processing is successful. In still other embodiments, a client application via which the financial transaction requestor may indicate a selection of a transaction option may submit, to the service provider system and in association with an indication of the selected transaction option, a request to originate a debit and/or a credit associated with the financial transaction. That is, in certain embodiments, the client application may submit the request to originate the debit and/or credit at the time the indication of the selected transaction option is conveyed to the service provider system. In those embodiments in which the debit is originated upon receipt of the complete financial transaction request (e.g., an indication of a selected transaction option, a transaction amount, etc.), the service provider system may transmit, for presentation to the requestor, an indication of successful or failed posting of the debit. Alternatively, such as, for example, if the credit is to be posted to a target financial account that is accessible in real-time by a corresponding target payment network, the service provider system may transmit an indication of success or failure of the entire financial transaction (rather than the debit alone) depending on whether the credit successfully posts to the target financial account, or alternatively, an indication of successful or failed posting of the credit alone such as in those scenarios in which processing of the debit does not occur via the service provider system.

In the event that the financial transaction is declined as a result of failed risk processing or failed transaction authorization processing or a debit fails to post to the source financial account, the requestor may be provided with the opportunity to select an alternative transaction option for the financial transaction. In certain embodiments, one or more of the transaction options initially presented to the requestor may no longer be available for selection based on the failure of the initially selected transaction option. Further, in various embodiments, one or more of the initially presented transaction options may be modified and the modified transaction option(s) may be presented to the requestor based on the failure of the initially selected transaction option.

In one or more additional embodiments of the disclosure, the service provider system may receive, on behalf of a financial transaction requestor, a financial transaction request associated with a financial transaction. The request may include information that identifies parties to the financial transaction through, for instance, a source identifier that identifies a first account holder of a financial account to be debited (e.g., a source account holder) and a target identifier that identifies a second account holder of a financial account to be credited (e.g., a target account holder). The request may further include an indication of a funds amount associated with the financial transaction, and may further optionally include an indication of a desired transaction posting date or a desired transaction issuance date. In certain embodiments, the desired transaction posting or transaction issuance date may be indicated via any suitable abstracted term (e.g., “immediate/same-day,” “next-day,” etc.). A transaction posting date and/or a transaction issuance date may be referred to herein generically as a “transaction date.”

Upon receipt of the financial transaction request, the service provider system may initiate transaction options optimization processing to identify a set of transaction options for the financial transaction. The service provider system may, prior to initiating the transaction options optimization processing, perform risk analysis processing associated with one or more of the source account holder, the target account holder, or the financial transaction requestor. In certain embodiments, the risk processing may form part of the transactions options optimization processing. After a set of transaction options are identified, the service provider system may proceed to analyze the set of transaction options to determine whether the financial transaction is executable (e.g., whether a transaction option exists that satisfies the desired transaction date and for which risk processing or transaction authorization processing is successful). The set of transaction options may first be ordered according to one or more criteria (e.g., an associated speed of the financial transaction, an associated cost of the financial transaction, a sponsor or service provider preference with respect to financial account(s) and/or payment network(s), etc.) prior to performing the analysis of the set of transaction options. If a transaction option is found for which the financial transaction is executable, the service provider system may transmit, potentially for presentation to the requestor, an indication that the financial transaction is executable. In certain embodiments, additional information such as associated fee(s) may be transmitted as well.

In various embodiments, a client application may support functionality that allows the requestor to approve the financial transaction after being presented with i) the indication that the financial transaction is executable and, optionally, ii) additional information such as an associated cost of the transaction. Upon receipt of an indication of approval to proceed with the financial transaction from the requestor, the client application may submit a request to the service provider system to originate a debit and/or a credit associated with the financial transaction. In other embodiments, the service provider system may optionally originate the debit and/or credit independently of a client application if it is determined that the financial transaction is executable.

In certain embodiments, the service provider system may halt the analysis of the set of transaction options upon identifying a transaction option for which the financial transaction is executable. In other embodiments, the service provider system may identify each transaction option for which the financial transaction is executable and may transmit information associated with each such transaction option for presentation to the requestor. In this manner, the requestor may select a desired transaction option. Transmitting information associated with multiple transaction options for which the requested financial transaction is executable may be desirable if, for example, different fees are associated with each transaction option.

Further, in those embodiments in which it is determined that no transaction option exists that satisfies the desired parameters associated with the financial transaction, information indicating that the financial transaction is not executable may be transmitted, potentially for presentation to the requestor. In certain embodiments, one or more alternate transaction options may be identified and information identifying such alternate transaction options may be transmitted, potentially for presentation to the requestor. The alternate transaction options may be associated with one or more modified financial transaction parameters including, but not limited to, a modified transaction date, a modified funds amount, and so forth. The requestor may be provided with an opportunity to select from among the alternative transaction options.

Various embodiments of the disclosure will now be described in more detail through reference to accompanying drawings.

### Illustrative Architectures

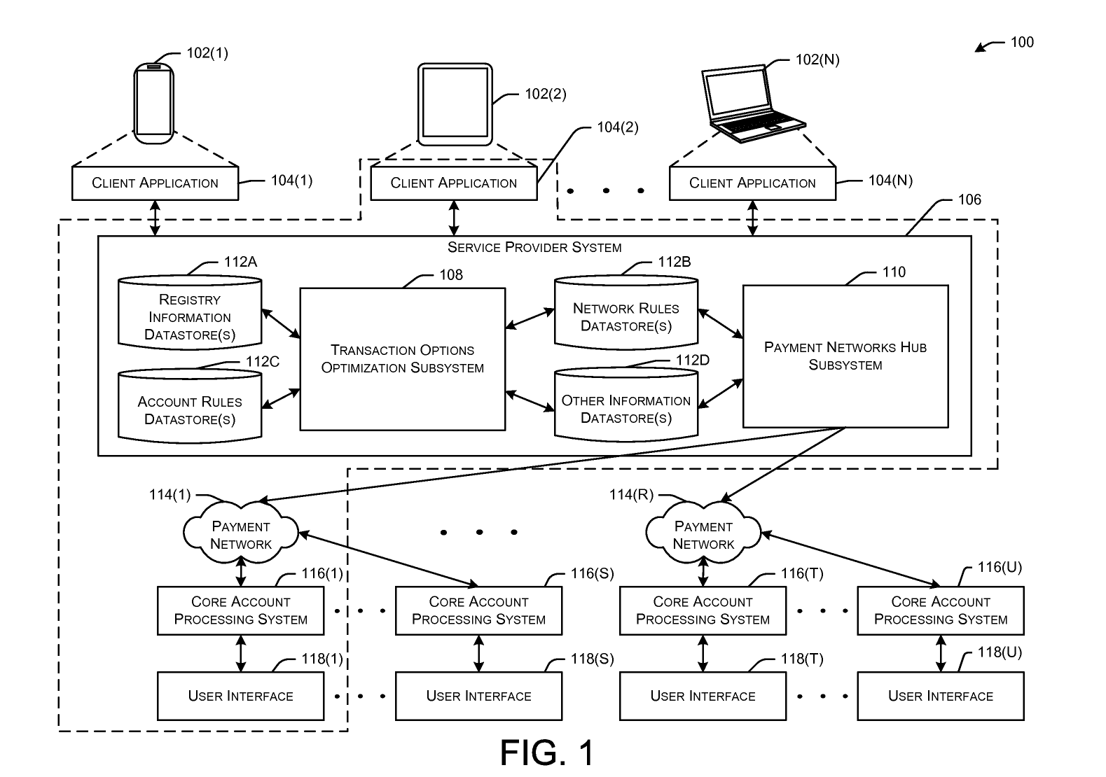

FIG. 1 schematically depicts an illustrative networked architecture 100 configured to support financial transaction options optimization processing in accordance with one or more embodiments of the disclosure. The illustrative architecture 100 may include a service provider system 106 that may include a transaction options optimization subsystem 108 and a payment networks hub subsystem 110. The service provider system 106 may be associated with one or more service providers. The transaction options optimization subsystem 108 and the payment networks hub subsystem 110 may include any suitable combination of hardware and/or software components including, but not limited to, one or more processor-driven devices, gateways, switches, routers, and so forth. The processor-driven devices may include, but are not limited to, a server device, a mainframe computing device, a workstation computing device, a personal computing device, and so forth. The processor-driven devices may include at least one memory storing computer-executable instructions and at least one processor configured to access the at least one memory and to execute the computer-executable instructions to perform or facilitate the performance of various operations disclosed herein.

As will be described in more detail later in this disclosure, the transaction options optimization subsystem 108 may support functionality for identifying candidate source and candidate target financial accounts, initiating and performing transaction options optimization processing, performing risk processing and/or transaction authorization processing, and so forth. Further, as will also be described in more detail later in this disclosure, the payment networks hub subsystem 110 may support functionality for communicating with various payment networks, performing risk processing and/or transaction authorization processing, originating debit and/or credit instructions to payment networks to post associated debit/credits to financial accounts, and so forth. It should be appreciated that in various embodiments certain functionality may be provided in a distributed fashion by the transaction options optimization subsystem 108 and the payment networks hub subsystem 110. Further, in certain embodiments, each of the transaction options optimization subsystem 108 and the payment networks hub subsystem 110 may support functionality not supported by the other subsystem. For example, in certain embodiments, risk processing and/or transaction authorization processing may be supported by the transaction options optimization subsystem 108 rather than the payment networks hub subsystem 110.

The illustrative architecture 100 may further include one or more client applications 104(1)-104(N). The variable N may represent any non-negative integer. The client applications 104(1)-104(N) may include any client products or services capable of leveraging functionality provided by the service provider system 106. Any of the client applications 104(1)-104(N) may be integrated with one or more other client applications 104(1)-104(N), or with other client application(s) that may not share similar connectivity to the service provider system 106 (e.g. wealth management applications, financial data aggregation applications, personal financial management applications, etc.). Although not depicted as part of the illustrative architecture 100, the client applications 104(1)-104(N) may be configured to communicate with the service provider system 106 via one or more networks which may include, but are not limited to, any one or a combination of different types of suitable communications networks, such as cable networks, the Internet, wireless networks, cellular networks, or any other private and/or public networks. Such network(s) may include, but are not limited to, wide area networks (WANs), metropolitan area networks (MANs), local area networks (LANs), personal area networks (PANs), mesh networks, cellular wireless networks, and so forth. Further, such network(s) may include any type of medium over which network traffic may be carried including, but not limited to, coaxial cable, twisted wire pair, optical fiber, hybrid fiber coaxial (HFC), microwave terrestrial transceivers, radio frequency communications, satellite communications, or combinations thereof.

The client applications 104(1)-104(N) may take on any of a variety of forms including, but not limited to, traditional stand-alone applications executing on a computing device (e.g., a personal computer), web-based applications accessible via a traditional browser or mobile browser interface, dedicated applications executing on a mobile device such as a smartphone or tablet device, and so forth. The client applications 104(1)-104(N) may also leverage toolkits including Application Programming Interfaces (APIs), software libraries, or the like that may be used to access functionality provided by the service provider system 106. Functionality supported by the client applications 104(1)-104(N) may be utilized or accessed via one or more user devices 102(1)-102(N) which may include, but are not limited to, a desktop computer, a laptop computer, a mobile device such as a smartphone or other device with cellular capabilities, a mobile tablet device with Internet connectivity and, optionally, cellular capabilities, a personal digital assistant (PDA), a gaming console, a set-top box, a smart television, a server computer, a mainframe computer, or any other suitable device. Certain of the client applications 104(1)-104(N) (e.g., “thin” clients such as browser-based client applications) may be supported by one or more server devices (including potentially a web server) that include combinations of hardware and software components for executing application functionality as well as by a local device (e.g., user device(s) 102(1)-102(N)) that provides a browser or other locally stored application for accessing the one or more server devices.

The client applications 104(1)-104(N) may support a variety of types of financial transactions. For example, one or more of the client applications 104(1)-104(N) may support person-to-person (P2P) payment functionality according to which a requestor may submit a request for a transfer of funds or a request to request a transfer of funds from a first financial account associated with the first account holder of the first financial account to a second financial account associated with a second account holder.

In addition, one or more of the client applications 104(1)-104(N) may support functionality that allows for the processing of financial transactions between financial accounts associated with a same account holder (e.g., a transfer of funds between financial accounts associated with a same account holder which does not involve another party) which may be referred to herein as an account-to-account transfer. In various embodiments, the requestor may be a same entity as the account holder of the financial accounts between which the funds are transferred while, in other embodiments, the requestor may be a different entity from the account holder, but one who is authorized to initiate the transaction. The financial account between which the funds are to be transferred may be associated with a same financial institution or with different financial institutions.

In addition, one or more of the client applications 104(1)-104(N) may support online opening and, optionally, funding of a financial account at a financial institution. Typically, financial institution rules specify that a new financial account must be funded with a minimum deposit at the time the account is opened. Accordingly, such client applications may support a transfer of funds to the newly opened account from another financial account that may be held at the same financial institution or at a different financial institution.

Further, one or more of the client applications 104(1)-104(N) may support bill presentment and payment functionality. Such client applications may support electronic presentment of a bill and/or payment of a payee. The payee, while typically a biller, may be any entity. In those embodiments in which the payee is a “managed electronic payee” (e.g., an electronic biller, other large payees, etc.), funds may be electronically transferred to a known account associated with the payee or via a known electronic remittance path.

Additionally, one or more of the client applications 104(1)-104(N) may support various types of deposit capture functionality. Deposit capture functionality may encompass the electronic capture and deposit of paper payment instruments through various mechanisms. Examples of deposit capture functionality that may be supported include deposit capture for consumers via either a personal computer or a mobile device, deposit capture performed by merchants, deposit capture performed by a financial institution such as processing of incoming checks by a financial institution or a lockbox processor, and so forth. Deposit capture functionality may be provided that supports the capture (e.g., remote capture) and processing or redemption in some manner by a financial institution of a payment instrument that may be drawn on a financial account held at a same financial institution or at a different financial institution.

In addition, one or more of the client applications 104(1)-104(N) may support any number of other types of transaction processing. For example, a retail or point-of-sale (POS) payment to a merchant for purchased goods or services may be supported, a “check guarantee” function or a similar funds sufficiency verification that a particular financial account exists and has sufficient funds associated therewith to support a financial transaction may be supported, and so forth. Further, one or more of any of the types of client applications discussed above may leverage an Application Programming Interface (API) such as, for example, a set of well-documented Web services that allows an entity to develop a user interface that accesses functionality provided by another entity.

Referring again to the service provider system 106, one or more datastores may be provided as part of the service provider system 106 such as one or more registry information datastores 112A, one or more network rules datastores 112B, one or more account rules datastores 112C, and one or more datastores 112D that may store any of a variety of other types of information. The transaction options optimization subsystem 108 and/or the payment networks hub subsystem 110 may be configured to access or receive information (via a service) from one or more of the datastores 112A-112D.

The registry information datastore(s) 112A may store one or more entity identifiers such as, for example, respective usernames associated with users of one or more of the client applications 104(1)-104(N), usernames associated with the service provider system 106, usernames associated with financial institutions (e.g., online banking usernames), government identifiers (e.g., a social security number, a tax identification number, etc.), respective identifiers associated with various payors or payees, user-specified identifiers for identifying respective payors or payees (e.g., a nickname), social networking identifiers, and so forth. Illustrative information stored in the registry information datastore(s) 112A may further include financial account identifiers, address or other user profile information, and so forth, which may, in various embodiments, also serve as entity identifiers. In addition, the registry information datastore(s) 112A may store information that identifies sponsors, financial accounts, and so forth. As a non-limiting example, a sponsor may include a financial institution that provides client application functionality to a customer and via which the customer may gain access to functionality provided by the service provider system 106. In certain embodiments, a user interface associated with the client application functionality may be hosted by the service provider system 106.

It should be appreciated that the above examples of information that may be stored in the registry information datastore(s) 112A are illustrative and not exhaustive and that any suitable information capable of identifying a user (e.g., an account holder of a financial account), an associated financial account, a sponsor, and so forth may be stored. It should further be appreciated that the registry information datastore(s) 112A may comprise a collection of datastores where one or more sets of datastores may each optionally be maintained by different entities and may each store respective registry information associated with client applications that operate in different financial transaction domains.

The network rules datastore(s) 112B may store information associated with one or more payment networks. Illustrative information that may be stored in the network rules datastore(s) 112B may include information associated with characteristics relating to the speed with which financial transactions may be processed by a payment network such as, for example, information that indicates timeframes for processing and posting of various types of financial transactions using the payment network. The information stored in the datastore(s) 112B may further include pricing or other cost-related information that indicates, for example, various fees or other costs associated with various financial transactions that may be processed using the payment network. In certain embodiments, tiered pricing information may be stored that indicates different costs for different transaction volumes, different transaction amounts, and so forth that occur over a given period of time.

In addition, information relating to constraints associated with financial transactions capable of being processed by a payment network may be stored in the network rules datastore(s) 112B. For example, information identifying constraint(s) that require an account holder that is a party to a financial transaction to be sponsored by another entity (e.g., a financial institution). As another non-limiting example, information identifying constraints on the types of financial accounts that may be accessed by a payment network and/or constraints associated with account holders of such financial accounts may be stored in the network rules datastore(s) 112B. For example, a particular payment network may only be available for use if certain constraints associated with an account holder are satisfied (e.g., the account holder is geographically located in a particular jurisdiction such as outside the U.S.) and a financial account associated with the account holder and capable of being accessed by the payment network is available.

The network rules datastore(s) 112B may further store information associated with point(s) of access to the payment network, communication protocol(s) supported by the payment network, formatting requirements for messages (e.g., debit or credit instructions) communicated to the payment network, type(s) of financial account(s) supported by the payment network, operating or trust account(s) associated with the payment network, various rule(s) of use associated with the payment network, or any other information that indicates one or more characteristics associated with the payment network.

The account rules datastore(s) 112C may store information associated with one or more financial accounts. Illustrative information stored in the account rules datastore(s) 112C may include, for example, information that indicates priorities or preferences for payment networks for various types of financial accounts. Preferences or priorities may also be designated for particular types of financial accounts. Preferences or priorities for payment networks and/or financial accounts may be designated or determined by any number of different entities associated with a financial account such as, for example, an account holder of the financial account, a financial institution at which the financial account is held, a sponsor, a service provider associated with the service provider system 106, and so forth. As a non-limiting example, an account holder may specify particular preferred payment network(s) for various types of financial accounts and/or financial transactions (e.g., a debit network for a credit to a Demand Deposit Account (DDA) as part of a P2P payment). In certain embodiments, a sponsor or service provider may designate preferences in an attempt to skew usage towards particular types of financial account(s) and/or payment network(s). For example, a sponsor or service provider may prevent use of a particular type of financial account as the target financial account if the same type of financial account is not also supported for the source account holder. As another non-limiting example, a sponsor or service provider may introduce a processing delay between posting of a debit and posting of a credit, charge various fees, and so forth for certain financial transactions in order to skew usage towards particular financial account(s) and/or payment network(s).

The information stored in the account rule datastore(s) 112C may further include other types of preference information for minimizing a cost or maximizing a speed of a financial transaction. Such preference information may include, for example, a preference for financial accounts in which associated funds are held in a like currency assuming that no other preferences would indicate otherwise. Information stored in the account rules datastore(s) 112C may further include information identifying geographical restrictions on potential payors and payees for whom a financial account is available for use, information identifying restrictions on the type of financial transactions for which the financial account is available for use, and so forth. For example, a financial account may not be available for use for a financial transaction that involves a payor or payee located in a particular geographical region (e.g., a non-US country). As another non-limiting example, a particular financial account may only be accessible via a particular payment network if a payor's sponsor is a financial institution. It should be appreciated that the above examples are merely illustrative and not exhaustive.

Illustrative information stored in the account rules datastore(s) 112C may further include information that identifies various limits associated with a financial account such as, for example, monetary limits, limits on transaction volumes over a given time period, limits on other characteristics associated with financial transactions involving the financial account, and so forth. Examples of monetary limits may include, but are not limited to, a maximum amount of funds that may be debited from a financial account over a given time period, a maximum amount of funds that may debited from the financial account for any given financial transaction, and so forth. Examples of limits on transaction volumes may include, but are not limited to, a maximum allowable number of debits from a financial account for a given time period, a maximum allowable number of credits to a financial account for a given time period, and so forth. An example of another type of limit that may be associated with a financial account may be a limit on the number of payees or recipients of funds from the financial account for a given time period. It should be appreciated the above examples of types of limits that may be associated with a financial account are merely illustrative and not exhaustive and that information associated with any number or type of limits associated with financial accounts may be stored in the datastore(s) 112C.

The one or more datastores 112D may store a variety of other types of information such as, for example, portions of financial account identifiers associated with financial accounts accessible by one or more payment networks. For example, Routing Transit Numbers (RTNs) associated with financial accounts accessible by a particular payment network, Bank Identification Numbers (BINs) or Issuer Identification Numbers (IINs) associated with financial accounts accessible by a particular payment network (e.g., a debit network), and so forth may be stored in the datastore(s) 112D. It should be appreciated that the above examples of information that may be stored in the datastore(s) 112D are merely illustrative and not exhaustive.

While the datastore(s) 112A-112D are depicted in FIG. 1 as forming part of the service provider system 106, it should be appreciated that, in certain embodiments, any one or more of the datastore(s) 112A-112D may be provided remotely from the service provider system 106 and may optionally be maintained by one or more entities different from a service provider associated with the service provider system 106. In certain embodiments, the service provider system 106 may utilize a service (e.g., a web service) to access one or more of the datastore(s) 112A-112D. More specifically, the service provider system 106 may submit a request for information to the service and may receive, in response, an indication as to whether the requested information is stored in one or more of the datastore(s) 112A-112D. For example, a request for registry information may be submitted to a service which may, in turn, access one or more datastores to determine whether the information is stored therein. Alternatively, the service may generate and submit another request for the information (or forward the received request) to another entity capable of accessing datastore(s) storing the registry information. In those embodiments in which the datastores 112A-112D are local datastores, information may be extracted from other data repositories and stored locally in the datastores 112A-112D. For example, service provider system 106 may periodically extract or be provided, from a payment network, with information (e.g., RTNs, BINs, IINs, etc.) associated with financial accounts accessible via the payment network and may store the information locally such as, for example, in the datastore(s) 112D.

While the transaction options optimization subsystem 108 is depicted as being configured to access each of the datastores 112A-112D and the payment networks hub subsystem 110 is depicted as being configured to access the network rules datastore(s) 112B and the datastore(s) 112D, it should be appreciated that other configurations are possible. For example, in certain embodiments, the payment networks hub subsystem 110 may be configured to access the registry information datastore(s) 112A and/or the account rules datastore(s) 112C as well. In addition, although the service provider system 106 is illustratively depicted in FIG. 1 as a single system, it should be appreciated that the service provider system 106 may comprise an architecture that includes multiple independent system(s) and/or payment gateways capable of communicating among one another to facilitate processing associated with financial transactions. Further, other components not depicted in FIG. 1 may be provided as part of the service provider system 106, and in certain embodiments, certain depicted components may not form part of the service provider system 106 (e.g., any of the datastores 112A-112D).

The illustrative architecture 100 may further include one or more payment networks 114(1)-114(R). The variable R may represent any non-negative integer. The payment networks 114(1)-114(R) may include any network capable of facilitating and/or performing processing of financial transactions involving financial accounts that are accessible via the payment network. The payment networks 114(1)-114(R) may include one or more payment networks that are capable of supporting real-time posting of debits and/or credits to financial accounts and/or one or more payment networks that are not capable of supporting real-time posting of debits and/or credits. The payment networks 114(1)-114(R) may include any of an Automated Clearing House (ACH) network, such as that supported by the Federal Reserve or the Electronic Payments Network (EPN), a proprietary network of financial institutions (e.g., a network formed as a result of an association between financial institutions and one or more common software components such as an ACH origination software component (e.g., PEP+®) or core account processing software (e.g., Premier® or Signature®), a real-time settlement network, a debit network (e.g., ACCEL/Exchange, STAR, PULSE, NYCE, etc.), a credit network (e.g., Visa Money Transfer (VMT)), or any other suitable payment network capable of facilitating the processing of financial transactions between member financial institutions or between a member financial institution and a non-member financial institution.

Each of the payment networks 114(1)-114(R) may support a respective set of one or more communicative links to the service provider system 106 and a respective set of one or more communicative links to each associated core account processing system (e.g., core account processing systems 116(1)-116(S) or core account processing systems 116(T)-116(U)). In certain embodiments, each core account processing system may be associated with a respective financial institution. The variables S, T and U may each represent respective non-negative integers. It should be appreciated that while elements 116(1)-116(S), 116(T)-116(U) may be referred to herein as core account processing systems, any combination of hardware and software components capable of providing core account processing functionality is encompassed.

In accordance with one or more embodiments of the disclosure, a financial institution may be communicatively linked to multiple different payment networks (e.g., an ACH network, a proprietary network of financial institutions, a debit network, etc.) such that financial accounts held at the financial institution may be accessed via the different payment networks. Respective modules associated with each of the payment networks may be integrated with a common core account processing system associated with the financial institution to support communication between the different payment networks and the core account processing system.

The illustrative architecture 100 may further include user interfaces (UIs) 118(1)-116(S), 118(T)-118(U) respectively associated with a corresponding core account processing system. The UIs 118(1)-118(S), 118(T)-118(U) may present financial account or transaction detail information associated with respective financial accounts to associated account holders or other users. The UIs 118(1)-118(S), 118(T)-118(U) may be in communication with respective ones of the core account processing systems in order to obtain the financial account or transaction detail information for presentation to the account holders or other users. While the UIs 118(1)-118(S), 118(T)-118(U) are depicted as being associated in a one-to-one correspondence with the core account processing systems 116(1)-116(S), 116(T)-116(U) in FIG. 1, it should be appreciated that, in various embodiments, at least one of the core account processing systems may have a plurality of UIs associated therewith.

As an illustrative example, payment network 114(1) may facilitate the processing of financial transactions between financial institutions that are members of the payment network 114(1) as well as, potentially, between member financial institutions and non-member financial institutions. Payment network 114(1) may be any of the types of payment networks previously described, and may or may not be capable of supporting real-time access to financial accounts held at financial institutions (e.g. real-time posting of debits and credits to financial accounts). Payment network 114(1) may support a set of one or more communicative links to the service provider system 106 and a respective set of one or more communicative links to each core account processing system 116(1)-116(S). Each of the core account processing systems 116(1)-116(S) may be associated with a respective financial institution. In accordance with various embodiments of the disclosure, the service provider system 106 (or more specifically the payment networks hub subsystem 110) may generate and transmit debit and/or credit instructions to the payment network 114(1) to post associated debits and/or credits to financial accounts accessible by the payment network 114(1). The payment network 114(1) may interact with one or more of the core account processing systems 116(1)-116(S) to post debits and/or credits to financial accounts held at corresponding financial institutions with which the core account processing systems 110(1)-110(S) are associated.

The debits and/or credits may or may not be posted in real-time to associated financial accounts. Whether a real-time debit or credit is capable of being posted to a particular financial account may be determined based on one or more parameters associated with the financial account, the financial institution at which the financial account is held, and/or the payment network to which a corresponding debit or credit instruction is transmitted. While the description above has been presented illustratively with respect to payment network 114(1), it should be appreciated that it is equally applicable to any of the payment networks 114(1)-114(R), any of the associated core account processing systems 116(1)-116(S), 115(T)-116(U), and/or any of the associated UIs 118(1)-118(S), 118(T)-118(U).

While not depicted in FIG. 1, each of the client applications 104(1)-104(N) may be associated with a respective user interface via which a user may interact with the client application. A user (e.g., a financial transaction requestor) may utilize the user interface to submit financial transaction requests. Further, as will be described in more detail later in this disclosure, transaction options information associated with available transaction options, information indicating whether a particular financial transaction that has been requested is executable, and so forth may be transmitted to a client application (e.g., any of client applications 104(1)-104(N)) for presentation to a requestor via an associated user interface. The financial transaction requestor may also utilize the user interface to indicate a selection of a transaction option, provide additional transaction parameters (e.g., a funds amount, a desired transaction date, etc.), and so forth. In certain embodiments, the service provider system 106 may host the user interface via which a requestor interacts with the client application.

In various embodiments, the service provider system 106 may provide functionality that forms part of a middle application layer of functionality between the client applications 104(1)-104(N) and the payment networks 114(1)-114(R). As indicated by the dashed lines in FIG. 1, in certain embodiments, the service provider system 106 may further include one or more of the client applications 104(1)-104(N) (e.g., client application 104(2)). As further indicated by the dashed lines, in various embodiments, one or more of the payment networks 114(1)-114(R) (e.g., payment network 114(1)) may form part of the service provider system 106 and may, for example, correspond to a proprietary payment network associated with a service provider with which the service provider system 106 is associated. In other embodiments, each of the client applications 104(1)-104(N) may be provided as stand-alone applications that are distinct from but capable of interacting with the service provider system 106 and providing access to the functionality supported by the service provider system 106. Further, in various embodiments, each of the payment networks 114(1)-114(R) may operate independently of the service provider system 106, but may provide the service provider system 106 with access to financial accounts held at various financial institutions. As also indicated by the dashed lines, in various embodiments, one or more of the core account processing systems (e.g., core account processing system 116(1)) and one or more of the UIs (e.g., UI 118(1)) may also form part of the service provider system 102.

In certain embodiments, one or more of the client applications 104(1)-104(N) may be capable of communicating with one or more payment networks independently of the service provider system 106. For example, a payment network (e.g., payment network 114(1)) may support a set of one or more communicative links that allow one or more of the client applications (e.g., client application 104(1)) to communicate with the payment network 114(1) independently of the service provider system 102 through, for example, pre-existing payment gateways. Accordingly, in various embodiments, the service provider system 106 may provide functionality for supporting a mixed-mode financial transaction. As used herein, a mixed-mode transaction may refer to a financial transaction in which either the debit or credit component of the transaction is processed through a payment processing infrastructure that does not include the service provider system 106. As a non-limiting example, a mixed-mode financial transaction may involve origination and transmission of a debit instruction or a credit instruction by a client application (e.g., client application 104(1)) to a payment network (e.g., payment network 114(1)) through an established payment processing infrastructure that may include one or more payment gateways and/or payment systems that do not form part of the service provider system 106.

While a particular illustrative networked architecture 100 is depicted in FIG. 1, it should be appreciated that numerous other configurations are within the scope of this disclosure. Further, some or all of the functionality described as being provided by a particular component of the networked architecture 100 may, in various embodiments, be performed by one or more other components.

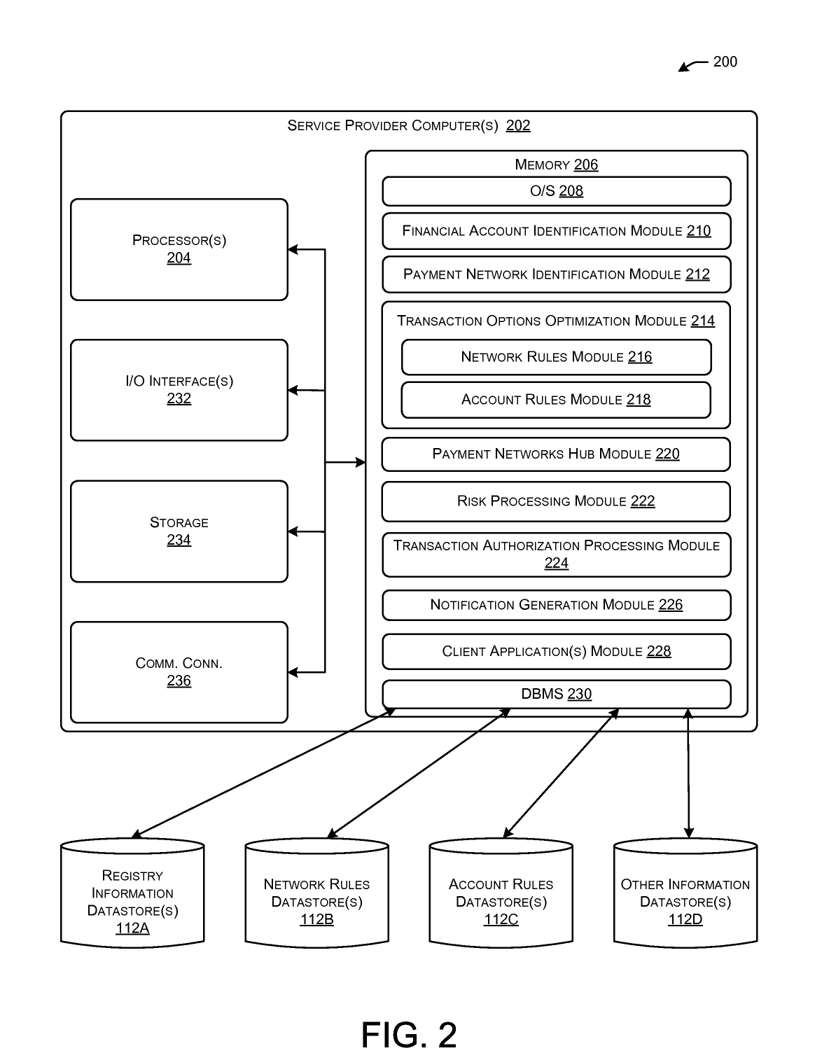

FIG. 2 depicts an illustrative service provider computer 202 in accordance with one or more embodiments of the disclosure. While the service provider computer 202 may, at times, be described herein in the singular, it should be appreciated that one or more service provider computers 202 may be provided, with each service provider computer 202 including all or some of the hardware and software components depicted in FIG. 2. The illustrative service provider computer 202 is depicted as including hardware and software components associated with functionality that may be provided by the transaction options optimization subsystem 108 and hardware and software components associated with functionality that may be provided by the payment networks hub subsystem 110. However, in certain embodiments, program module(s) that provide functionality associated with the transaction options optimization subsystem 108 may be provided as part of a first set of one or more service provider computers forming part of the transaction options optimization subsystem 108 while program module(s) that provide functionality associated with the payment networks hub subsystem 110 may be provided as part of a different set of one or more service provider computers forming part of the payment networks hub subsystem 110. As such, some of the program modules depicted as forming part of the illustrative service provider computer 202 may not be present in connection with all service provider computers 202 that may form part of service provider system 106. Further, in those embodiments in which functionality provided by any of the payment networks 114(1)-114(R), any of the core account processing systems 116(1)-116(S), 116T)-116(U), and/or any of the user interfaces 118(1)-118(S), 118(T)-118(U) is supported by the service provider system 106, such functionality may be provided by program module(s) provided on one or more computers, which may include the service provider computer 202 or any other computing device(s).

The service provider computer 202 may include one or more processors 204 and one or more memories 206 (generically referred to herein as memory 206). The processor(s) 204 may include any suitable processing unit capable of accepting digital data as input, processing the input data based on stored computer-executable instructions, and generating output data. The computer-executable instructions may be stored, for example, in the at least one memory 206 and may include, for example, operating system software and application software. The processor(s) 204 may be configured to execute the computer-executable instructions to cause various operations to be performed. The processor(s) 204 may include any type of processing unit including, but not limited to, a central processing unit, a microprocessor, a Reduced Instruction Set Computer (RISC) microprocessor, a microcontroller, an Application Specific Integrated Circuit (ASIC), and so forth.

The memory 206 may store program instructions that are loadable and executable by the processor(s) 204, as well as data manipulated by the processor(s) 204 and data generated by the processor(s) 204 during the execution of the program instructions. Depending on the configuration and implementation of the service provider computer 202, the memory 206 may be volatile memory (memory that is not configured to retain stored information when not supplied with power) such as random access memory (RAM) and/or non-volatile (memory that is configured to retain stored information even when not supplied with power) such as read-only memory (ROM), flash memory, and so forth. In various implementations, the memory 206 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The service provider computer 202 may further include additional data storage 234 such as removable storage and/or non-removable storage including, but not limited to, magnetic storage, optical disk storage, and/or tape storage. Data storage 234 may provide storage of computer-executable instructions and other data. The data storage 234 may include storage that is internal and/or external to the service provider computer 202. The memory 206 and/or the data storage 234, removable and/or non-removable, are all examples of computer-readable storage media (CRSM).

The service provider computer 202 may further include communications connection(s) 236 that allow the service provider computer 202 to communicate with other computing devices or application software forming part of the networked architecture 100. For example, the service provider computer 202 may utilize the communications connection(s) 236 to communicate with any of the client applications 104(1)-104(N), any of the payment networks 114(1)-114(R), and so forth.

The service provider computer 202 may additionally include input/output (I/O) interfaces(s) 232 (and optionally associated software components such as device drivers) that may support a various I/O devices, such as a keyboard, a mouse, a pen, a voice input device, a touch input device, a display, speakers, a camera, a microphone, a printer, and so forth, for receiving user input and/or providing output to a user.

The memory 206 may include various program modules comprising computer-executable instructions that upon execution by the processor(s) 204 may cause the service provider computer 202 to perform various operations. For example, the memory 206 may have loaded therein an operating system (O/S) 208 that provides an interface between other application software executing on the service provider computer 202 and hardware resources of the service provider computer 202. More specifically, the O/S 208 may include a set of computer-executable instructions for managing hardware resources of the service provider computer 202 and for providing common services to other application programs (e.g., managing memory allocation among various application programs). The O/S 208 may include any operating system now known or which may be developed in the future including, but not limited to, a Microsoft Windows® operating system, an Apple OSX™ operating system, Linux, Unix, a mainframe operating system such as Z/OS, a mobile operating system, or any other proprietary or freely available operating system.

The memory 206 may further include a database management system (DBMS) 230 for accessing, retrieving, storing, and/or manipulating data stored in one or more datastores (e.g., any of the datastores 112A-112D). The DBMS 230 may use any of a variety of database models (e.g., relational model, object model, etc.) and may support any of a variety of query languages.

The memory 206 may further include various program modules comprising computer-executable instructions that upon execution by the processor(s) 204 may cause the service provider computer 202 to perform various operations. For example, the memory 206 may store a financial account identification module 210, a payment network identification module 212, a transaction options optimization module 214 (which may, in turn, include a network rules module 216 and an account rules module 218), a payment networks hub module 220, a risk processing module 222, a transaction authorization processing module 224, a status indication generation module 226, and a client application(s) module 228. Each program module may be a logical grouping that includes functionality supported by one or more software components.

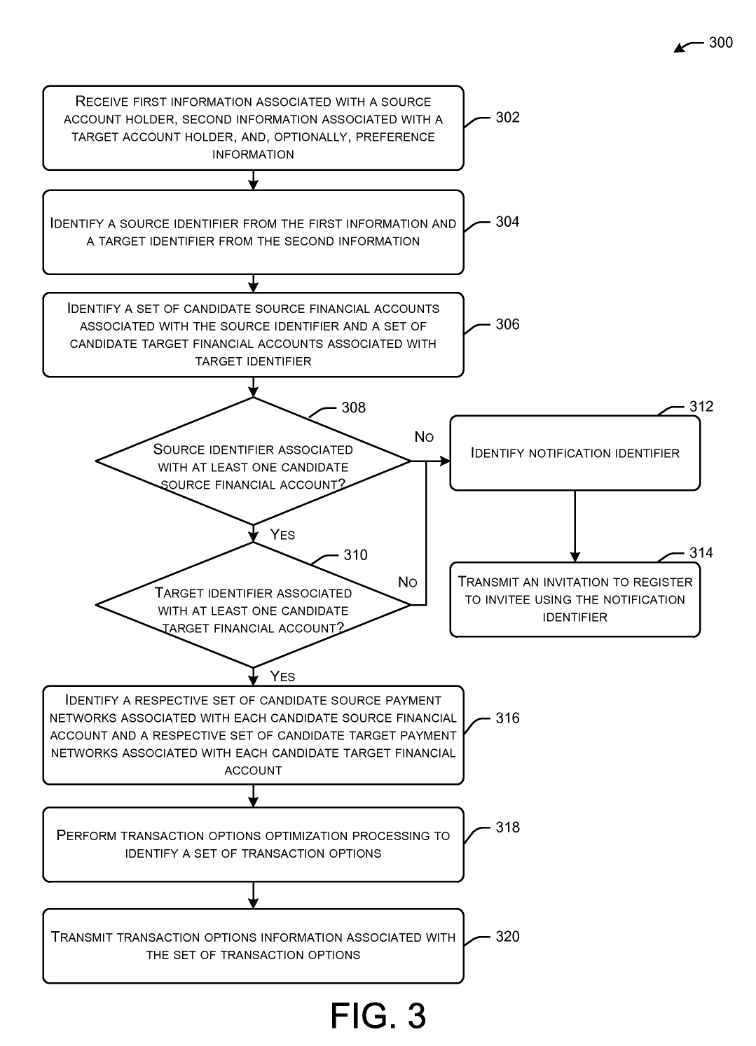

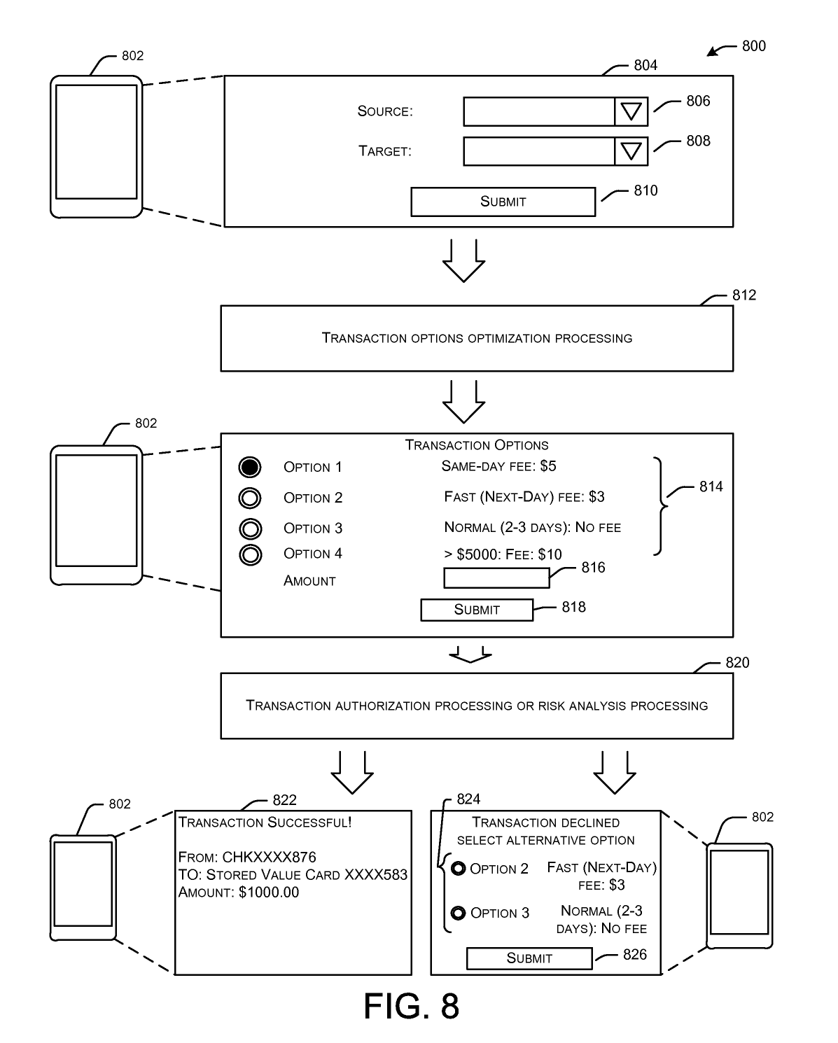

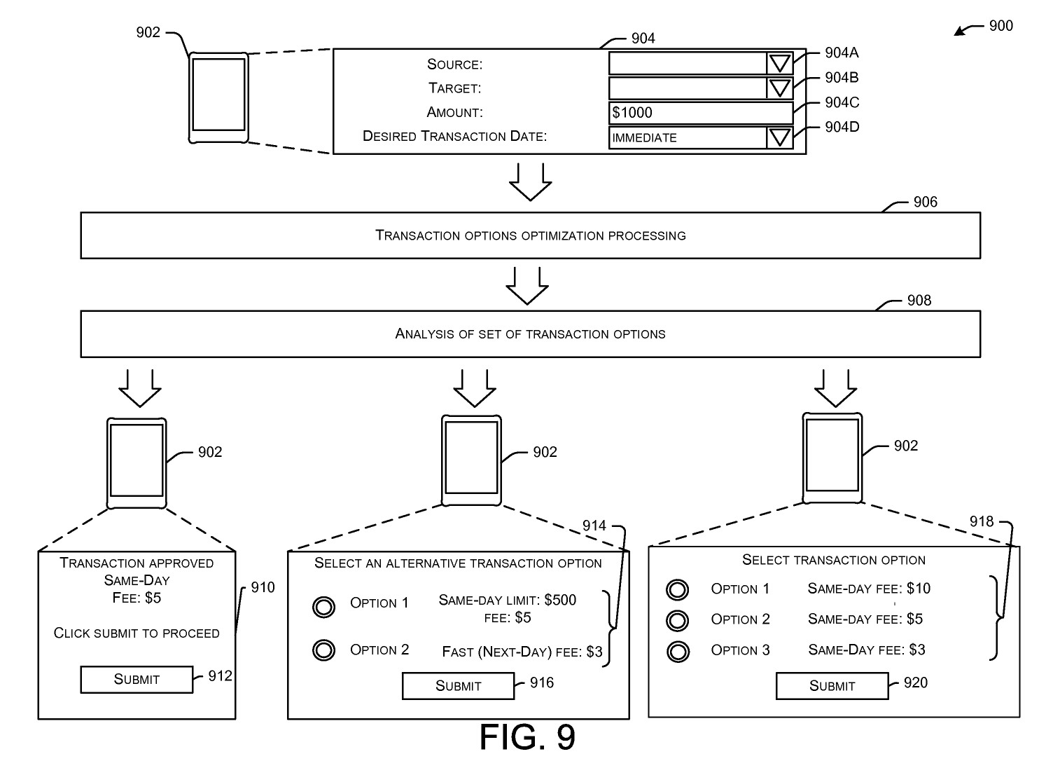

It should be appreciated that functionality described herein as being provided by a particular program module may, in various embodiments, be performed by one or more other depicted program modules and/or by one or more additional modules not depicted. In addition, in various embodiments, one or more program modules may be present for providing functionality associated with payment network(s), core account processing system(s), associated user interface(s), and so forth when such functionality is supported by the service provider system 106. Further, in various embodiments, certain program modules that are depicted may not be provided. The functionality provided by various program/application modules will be described in more detail hereinafter through reference to the various illustrative methods depicted in FIGS. 3-7 and the illustrative use cases depicted in FIGS. 8-9.

### Illustrative Processes

FIG. 3 is a process flow diagram depicting an illustrative method 300 for identifying candidate source and target financial accounts and associated candidate payment networks and performing transaction options optimization processing in accordance with one or more embodiments of the disclosure.

At block 302 of the illustrative method 300, first information associated with a source account holder, second information associated with a target account holder, and, optionally, preference information may be received by the service provider system 106. For example, the first information, the second information, and the optional preference information may be received from a client application (e.g., any of the client applications 104(1)-104(N)) on behalf of a financial transaction requestor. Alternatively, such as in those embodiments in which the client application forms part of the service provider system 106, the above-described information may be received from a user (e.g., the financial transaction requestor) of the client application via, for example, a user interface associated with the client application. In certain embodiments, the service provider system 106 may receive the above-described information based on input received from the requestor (e.g., free-form input that may optionally be validated, a selection of pre-existing options, etc.) via a user interface associated with the client application. At block 304, the service provider system 106 may identify a source identifier and a target identifier included in the first information and the second information, respectively. The source and target identifiers may correspond to any of the types of identifiers previously described.

At block 306, computer-executable instructions provided, for example, as part of a financial account identification module 210 may be executed by the processor(s) 204 to identify a set of candidate source financial accounts associated with the source identifier and a set of candidate target financial accounts associated with the target identifier. The set of candidate source financial accounts and the set of candidate target financial accounts may be identified, for example, by accessing the registry information datastore(s) 112A and performing a lookup of financial accounts associated with the source identifier or the target identifier. As previously described, a service (e.g., a web service) may be leveraged to access registry information that may be stored locally in association with the service provider system 106 or remotely from the service provider system 106. Further, in those embodiments in which preference information is received, the set of candidate source financial accounts and/or the set of candidate target financial accounts may be identified further based at least in part on the preference information. In addition, any candidate source financial accounts and/or candidate target financial accounts that are identified may be ordered or prioritized based on preference information that may be received.

At block 308, a determination may be made as to whether at least one financial account has been identified as being associated with the source identifier. If a determination is made at block 308 that at least one source financial account has been identified based on the source identifier, the method 300 may proceed to block 310 at which point a determination may be made as to whether at least one financial account has been identified as being associated with the target identifier. If a determination is made at block 310 that at least one target financial account has been identified based on the target identifier, the method 300 may proceed to block 316 where a respective set of candidate source payment networks may be identified for each candidate source financial account and a respective set of candidate target payment networks may be identified for each candidate target financial account. In certain embodiments, the respective sets of candidate source payment networks and candidate target payment networks may be identified upon execution of computer-executable instructions provided as part of the payment network identification module 212.

The respective sets of candidate source and candidate target payment networks may be identified in any of a variety of suitable ways. For example, for a given financial account (e.g., a candidate source financial account), a lookup may be performed of information stored, for example, in the datastore(s) 112D. More specifically, a lookup may be performed to determine whether at least a portion of an RTN, IIN, and/or BIN associated with the financial account is stored in association with one or payment networks, and if so, such payment networks may be identified as candidate payment networks for that financial account. RTNs, IINs, and/or BINs associated with various payment networks may be periodically received or extracted from the respective payment networks and stored in, for example, the datastore(s) 112D. Alternatively, or additionally, a service (e.g., a web service) may be leveraged to access information that may be stored locally in association with the service provider system 106 or remotely from the service provider system 106. More specifically, the service provider system 106 may transmit a request to a service to identify one or more payment networks capable of accessing a financial account. Utilizing a service to identify a candidate payment network may obviate the need for the service provider system 106 to locally store information relating to associations between financial accounts and payment networks.

If no candidate source financial account is identified at block 308 based on the source identifier or if no candidate target financial account is identified at block 310 based on the target identifier, it may be assumed that the source identifier or the target identifier, as the case may be, is not associated with an account holder registered with the service provider system 106. Accordingly, the method 300 may proceed to block 312 where a notification identifier may be identified based on the source identifier or the target identifier. In certain embodiments, the source identifier or the target identifier may be a contact identifier (e.g., an electronic mail address, a phone number, etc.), and thus may serve as the notification identifier. At block 314, an invitation to register with the service provider system 106 may be transmitted to an invitee using the notification identifier that is identified at block 312. In those embodiments in which no candidate source financial account is identified, the invitee may be an account holder identified by the source identifier. In those embodiments in which no candidate target financial account is identified, the invitee may be an account holder identified by the target identifier. Although the determinations at blocks 308 and 310 are depicted as occurring sequentially, it should be appreciated that, in various embodiments, the determinations may occur in parallel. Accordingly, if no candidate source financial account is identified and no candidate target financial account is identified, respective notification identifiers associated with the source account holder and the target account holder may be identified and corresponding invitations to register may be transmitted using the respective notification identifiers. In certain embodiments, upon transmission of the invitation to register, the invitee may proceed to register with the service provider system 106. As part of registering with the service provider system 106, the registrant may provide various information including, but not limited to, identifiers (e.g., entity identifiers, financial account identifiers, etc.), preference information relating to financial accounts and/or payment networks, and so forth. In certain embodiments, the service provider system 106 may receive the information described through reference to block 302 from the registrant and processing may proceed as described above.

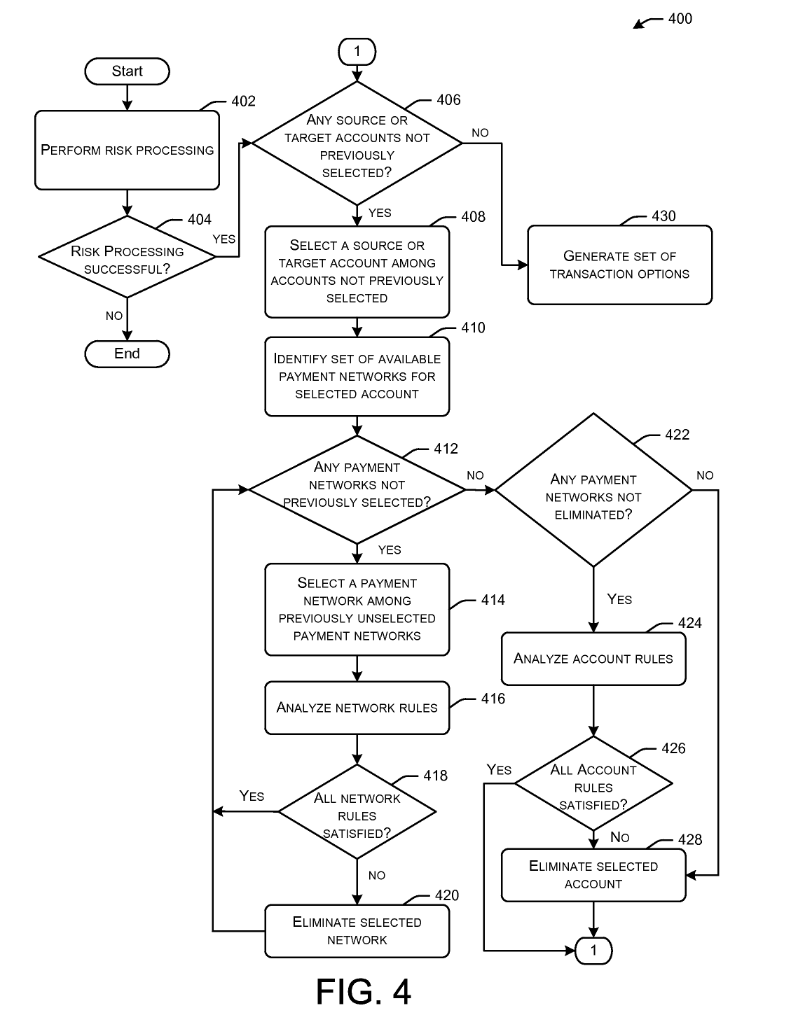

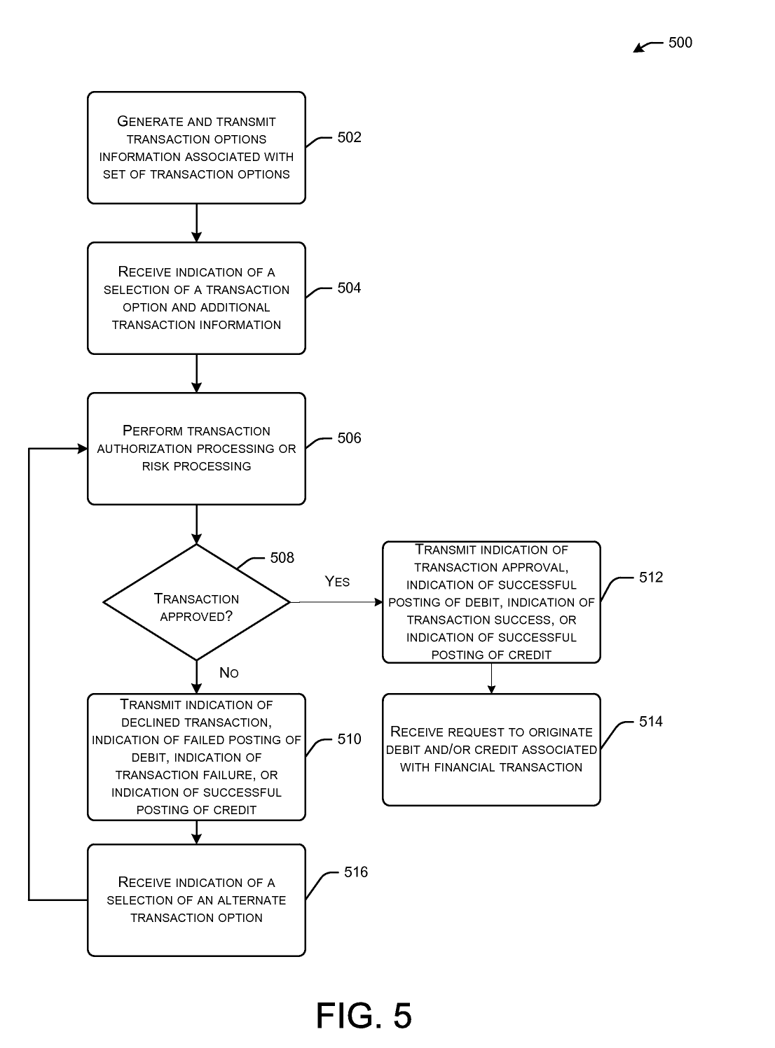

Referring again to the operations at block 316, upon identification of respective sets of candidate source payment networks and respective sets of candidate target payment networks, transaction options optimization processing may be performed at block 318 to identify a set of transaction options. The transaction options optimization processing may be performed, for example, upon execution of computer-executable instructions provided as part of the transaction options optimization module 214. The transaction options optimization processing performed at block 318 will be described in varying levels of detail through reference to FIGS. 4-9. As part of the transaction options optimization processing, transaction options information associated with the set of transaction options may be generated and transmitted, at block 320, potentially for presentation to a financial transaction requestor. Further processing that may be performed subsequent to transmission of the transaction options information will be described in more detail through reference to the illustrative method depicted in FIG. 5.

While the identification of candidate source and target financial accounts and candidate source and target payment networks is depicted in FIG. 3 as being distinct from the transaction options optimization processing, it should be appreciated that, in various embodiments, identification of the candidate source and target financial accounts and/or identification of the candidate source and target payment networks may form part of the transaction options optimization processing and may, for example, be performed upon execution of computer-executable instructions provided as part of the transaction options optimization module 214.

Once a set of transaction options are identified at block 318, transaction options information associated with the set of transaction options may be transmitted at block 320. The transaction options information may be transmitted, potentially for presentation to a financial transaction requestor. The nature and scope of the transaction options information that may be transmitted will be described in greater detail through reference to at least FIG. 5.

FIG. 4 is a process flow diagram depicting an illustrative method 400 for performing transaction options optimization processing in accordance with one or more embodiments of the disclosure. The illustrative method 400 assumes that the identification of candidate source and target payment networks forms part of the transaction options optimization processing; however, in some embodiments, this may not be the case.

At block 402, risk processing associated with the source account holder, the target account holder, and/or the financial transaction requestor (if the requestor is a different entity from the source and target account holders) may be performed. The risk processing may include identity verification processing, account access authorization processing, fraud detection or mitigation processing, credit-worthiness determination processing, and so forth. The risk processing may involve an assessment of various characteristics associated with the financial transaction requestor, the source account holder, and/or the target account holder with respect to various risk analysis parameters in order to determine whether an identified risk is acceptable for proceeding with further transaction options optimization processing. As a complete financial transaction request may not have been received at this stage in the process flow (e.g., a transaction amount may not have been received), the risk processing may not involve an assessment of attributes associated with the financial transaction itself. The risk processing may be performed, for example, upon execution, by the processor(s) 204, of computer-executable instructions provided as part of the risking processing module 222.

Identity verification may involve processing to determine whether the requestor is who he/she purports to be such as, for example, the source account holder, the target account holder, or an entity authorized by the source account holder or the target account holder to initiate the financial transaction request. Account access authorization may involve processing to determine that the requestor is legitimately associated with the identified candidate source financial accounts or the candidate target financial accounts, or has been provided authorization to initiate the financial transaction request by someone who is legitimately associated with the identified candidate source financial accounts or the candidate target financial accounts. Fraud detection or mitigation processing may include processing to determine whether indications of potential fraudulent activity exist. Fraud detection or mitigation processing may be based on one or more of: 1) information associated with a profile of the requestor (e.g., demographic information, information associated with one or more prior transactions, etc.), 2) information associated with the financial transaction request itself (e.g., the time at which the request was submitted, the location from which the request was submitted, etc.), 3) information associated with parties to the financial transaction, 4) information associated with prior financial transactions (e.g., funds amounts associated with prior transactions, a number of prior transactions requested and/or completed over a given period of time, etc.), and so forth. The prior transactions that may be analyzed may be associated with at least one of: the source account holder, the target account holder, or the financial transaction requestor. In various embodiments, a complete financial transaction request may not have been received at this stage in the processing, and as such, certain types of fraud detection/mitigation processing may not be capable of being performed. In such embodiments, the fraud detection/mitigation processing performed at this stage may be processing associated with one or more entities associated with the financial transaction.

It should be appreciated that, in various embodiments, some overlap may exist among the analyses performed as part of the identity verification processing, the account access authorization processing, and/or the fraud detection or mitigation processing. Further, any one or more of the risk processing relating to identity verification, account access authorization, or fraud detection or mitigation may involve interaction with one or more third parties to assist in the processing (e.g., provide access to externally stored information).

At block 404, a determination may be made as to whether a risk identified by the risk processing performed at block 402 is acceptable for proceeding with further transaction options optimization processing. If it is determined that the risk is not acceptable, the method 400 may end and no further transaction options optimization processing may be performed. Optionally, an indication of failure of the risk processing may be transmitted, potentially for presentation to the requestor. The indication that the risk processing has failed may further be transmitted to one or more notification identifiers associated with the source account holder and/or the target account holder. The indication that the risk processing has failed may be generated and transmitted, for example, upon execution, by the processor(s) 204, of computer-executable instructions provided as part of the notification generation module 226.

On the other hand, if it is determined that the risk identified by the risk processing is acceptable, the method 400 may proceed to block 406 where a determination may be made as to whether any candidate source financial accounts and/or candidate target financial accounts remain that have not previously been selected. One or more of the operations depicted in blocks 406-430 may be performed, for example, upon execution of computer-executable instructions provided as part of the transaction options optimization module 214. Further, the operations performed at blocks 406-428 may represent an iterative cycle forming part of the transaction options optimization processing in which each candidate source financial account and each candidate target financial account is iterated through to generate a set of transaction options. Accordingly, in a first iteration, no candidate source or candidate target financial accounts are likely to have been previously selected, and as such, the method 400 may proceed to block 408 where a candidate source financial account or a candidate target financial account that has not previously selected may be selected for further transaction options optimization processing.

A candidate source financial account or a candidate target financial account may be selected according to any suitable methodology. For example, the candidate financial accounts may be ordered or prioritized in accordance with preference information that may have been received on behalf of the requestor or otherwise obtained by the service provider system 106. If ordered based on one or more preferences specified by the requestor, the source account holder, the target account holder, a financial institution, and/or a sponsor, the candidate source and candidate target financial accounts may be selected for further processing in accordance with the determined ordering. Accordingly, while the illustrative method 400 depicts iterating through each of the candidate source and candidate target financial accounts, in certain embodiments, a subset of the identified financial accounts may be selected based on preference information and transaction options optimization processing may be performed on the selected subset of financial accounts. Further, in other embodiments, the financial accounts may be ordered or prioritized in accordance with preference information and transaction options optimization processing may be performed until a threshold number of transaction options are generated, at which point transaction options information associated with the generated transaction options may be generated and transmitted, potentially for presentation to a financial transaction requestor. However, as the illustrative method 400 depicts iterating through each of the candidate source and candidate target financial accounts, in certain embodiments, the financial accounts may not be ordered or prioritized, and instead each financial account may be iterated through without designating any particular order for the accounts.

At block 410, a set of available payment networks may be identified for the selected financial account. If the selected account is a candidate source financial account, candidate source payment networks capable of accessing the selected candidate source financial account may be identified. Similarly, if the selected account is a candidate target financial account, candidate target payment networks capable of accessing the selected candidate target financial account may be identified. In certain embodiments, the candidate payment networks identified at block 410 may include payment network(s) capable of accessing the selected financial account in real-time. It should be appreciated that, in certain embodiments, the processing to identify candidate payment networks may not be performed as part of the transaction options optimization processing, and may instead be performed prior to initiation of such processing, for example, at block 316 (FIG. 3).

Blocks 412-420 may represent a portion of the transaction options optimization processing in which the set of candidate payment networks identified at block 410 is iterated through to determine if any of the candidate payment network(s) are eligible for processing the financial transaction request. At block 412, a determination may be made as to whether any candidate payment networks remain that have not previously been selected. At a first iteration, if no candidate payment networks are identified at block 410, negative determinations may be made at blocks 412 and 422 and the selected financial account may be eliminated from consideration. Alternatively, if at least one payment network is identified at block 410, a positive determination may be made at block 412 during a first iteration and the method 400 may proceed to block 414.

At block 414, a candidate payment network may be selected among the payment networks that have not previously been selected. The payment network may be selected according to any suitable methodology. At block 416, one or more network rules associated with the selected payment network may be analyzed upon execution, for example, of computer-executable instructions provided as part of the network rules module 216. The network rules may include any of those previously described and may be stored in and accessed from the network rules datastore(s) 112B. In certain embodiments, no network rules may be associated with the selected payment network.

At block 418, a determination may be made as to whether all network rules associated with the selected payment network are satisfied. In certain embodiments, one or more network rules may conflict with received preference information, in which case it may be determined at block 418 that not all network rules are satisfied, and the method 400 may proceed to block 420 where the selected payment network is eliminated from consideration for use in association with the selected financial account. It should be appreciated that one or more network rules may fail to be satisfied for any number of reasons including reasons others than a conflict between the one or more of the network rules and preference information. For example, network rules associated with geographical restrictions on account holders, network rules requiring sponsorship by a financial institution, and so forth may be analyzed and may fail to be satisfied. If, on the other hand, all network rules are determined to be satisfied at block 418 (or alternatively no network rules associated with the selected payment network were identified at block 416), the selected payment network may be maintained as an optional payment network for processing the financial transaction. While a particular payment network may be eliminated for use in connection with a particular financial account, it should be appreciated that the same payment network may nonetheless be determined to be available for use in connection with a different financial account upon performance of transaction options optimization processing in connection with the different financial account.

Upon an affirmative determination at block 418 that all identified network rules associated with the selected payment network are satisfied, the method 400 may proceed once again to block 412 where a determination may be made as to whether any payment networks remain that have not previously been selected for further transaction options optimization processing. If unselected payment networks remain for the selected candidate financial account, the iterative process of blocks 412-420 may continue until transaction options optimization processing has been performed in connection with each candidate payment network identified for the selected financial account.

If all candidate payment networks associated with the selected candidate financial account have been processed, a negative determination may be made at block 412, and the method 400 may proceed to block 422 where a determination may be made as to whether any payment networks remain under consideration for the selected account after the iterative process described above is performed. More specifically, a determination may be made at block 422 as to whether a respective set of network rules was satisfied for any of the candidate payment networks identified for the selected candidate financial account. If all candidate payment networks were eliminated as part of the processing performed at blocks 412-420, the method 400 may proceed to block 428 and the selected financial account may be eliminated as an option for the requested financial transaction.

On the other hand, if at least one candidate payment network has not been eliminated as an option for use in connection with the selected financial account, a positive determination may be made at block 422, and the method 400 may proceed to block 424 where a set of account rules associated with the financial account may be analyzed. The account rules may be stored in the account rules datastore(s) 112C and accessed or otherwise obtained by the service provider system 106. The account rules may include any of the types of rules previously discussed such as, for example, payment network prioritization, preferences, or requirements, various type of limits (e.g., monetary limits, transaction volume limits), and so forth.

At block 426, a determination may be made as to whether all account rules associated with the selected financial account are satisfied based at least in part on the analysis performed at block 424. As a non-limiting example, a financial account may have an associated limit on the amount of funds that may be debited from the financial account in the form of P2P payments or the like over a given time period. If that limit has been reached, the associated financial account rule is not satisfied, and the selected account may be eliminated as a candidate financial account. As another non-limiting example, an account holder associated with the selected financial account may have reached a maximum number of transactions permitted over a given period of time. In such a scenario, the associated financial account rule is not satisfied, and the selected account may be eliminated as a candidate financial account. As yet another non-limiting example, even though a payment network is capable of accessing a particular financial account, preferences associated with an account holder, a sponsor, and/or service provider may indicate that payment network is not available use in connection with a particular financial account. As such, although network rules associated with a candidate payment network may be satisfied in connection with a particular selected financial account, account rules associated with the financial account may result in later elimination of the payment network for that financial account. Further, if no payment network remains under consideration for a particular selected financial account after one or more payment networks are later eliminated based on an analysis of account rules, the selected financial account may be eliminated for use in connection with the financial transaction.

In various embodiments, certain rules relating to an assessment of the risk associated with a financial transaction (e.g., limits on the amount of funds that may be transferred from one entity to another for a given transaction or for a group of transactions over a given time period, limits on the number of transactions for a given time period, etc.) may be network rules associated with a payment network rather than account rules associated with a financial account. For example, certain such rules may not be satisfied for a particular payment network, but may be satisfied for the same financial account in connection with a different payment network. Further, in various embodiments, some degree of overlap may exist between account rules and network rules. It should be appreciated that the above examples of account rules are merely illustrative and not exhaustive and that any of a variety of types of account rules may be associated with a financial account.

If it is determined at block 426 that all account rules associated with the selected financial account are satisfied (or alternatively if no account rules are identified at block 424), the financial account may remain eligible for the requested financial transaction, and the method 400 may proceed once again to block 406. On the other hand, if it is determined at block 426 that at least one account rule is not satisfied, the selected financial account may be eliminated as a candidate financial account of the requested financial transaction, and the method 400 may proceed once again to block 406. All or some of the processing performed at blocks 422-428 may be performed upon execution, by the processor(s) 204, of computer-executable instructions provided as part of the account rules module 218.

At block 406, as described earlier, a determination may be made as to whether any candidate source or target financial accounts remain that have not previously been selected for further transaction options optimization processing. In this manner, the transaction options optimization processing may iterate through each of the candidate source and target financial accounts to determine which, if any, are eligible for use in connection with the requested financial transaction. The illustrative method 400 depicts transaction options optimization processing in which the payment networks are iterated through to determine whether associated network rules are satisfied prior to determining whether account rules are satisfied. However, in certain embodiments, a determination with respect to the account rules may be made prior to iterating through the payment networks to determine whether associated network rules are satisfied.

If it is determined at block 406 that no candidate source or target financial accounts remain that have not been selected for further transaction options optimization processing, the method 400 may proceed to block 430. At block 430, a set of transaction options may be generated. In certain embodiments, no candidate source financial account and/or no candidate target financial account may remain under consideration in connection with a particular financial transaction request after the transaction options optimization processing is performed, in which case, no transaction options may be generated. Further, in various embodiments, no candidate source and/or candidate target financial accounts may have been identified initially, in which case, no transaction options may be generated.

Each transaction option may include a particular combination of a candidate source financial account, a candidate source payment network, a candidate target financial account, and a candidate target payment network that have been deemed eligible for use in connection with the requested financial transaction based on the transaction options optimization processing. Each transaction option may further include a set of one or more transaction characteristics that may relate to one or more parameters including, but not limited to, a speed of the financial transaction (e.g., “immediate” or “same day,” “next day,” another transaction date in the future, etc.), a cost associated with processing the financial transaction, a maximum allowable amount of funds that may be transferred, a minimum amount of funds that must be transferred, and so forth. It should be appreciated that there may be some overlap among transaction options. For example, two transaction options may share a same candidate source financial account, a same candidate source payment network, a same candidate target financial account, a same candidate target payment network, and/or a same at least one transaction characteristic. Further processing that may occur upon generation of the set of transaction options at block 430 will be described in more detail hereinafter.

FIG. 5 is a process flow diagram depicting an illustrative method 500 for generating and transmitting transaction options information associated with a set of transaction options identified based on transaction options optimization processing, receiving an indication of a selection of a transaction option, and performing additional processing based on the selected transaction option in accordance with one or more embodiments of the disclosure.

At block 502, transaction options information associated with a set of transaction options may be generated and transmitted, potentially to a client application (e.g., any of client applications 104(1)-104(N)) for presentation to a financial transaction requestor. In certain embodiments, the transaction options information may be transmitted to another application or service that holds the information for later presentation via a client application to a financial transaction requestor (e.g., a non-real-time or non-in-session presentation).

For each transaction option, the corresponding transaction options information potentially presented to the requestor may represent an abstraction of the underlying transaction option details. For example, the requestor may be provided with an indication of a speed or other transaction characteristic associated with the transaction option in an abstracted form (e.g., “normal,” “fast/expedited,” “immediate/same-day,” “high transfer amount”). The requestor may also be provided with indications of fees associated with each transaction option. Thus, in certain embodiments, other transaction option details (e.g., the candidate source and target financial accounts, the candidate source and target payment networks, etc.) may be hidden from the requestor. However, in other embodiments, the transaction options information presented to the requestor may include information indicating all or some of the transaction option details associated with a transaction option. Further, in various embodiments, the transaction options information may be ordered or prioritized based on preferences specified by the requestor, the source account holder, the target account holder, a financial institution, a sponsor, a service provider, and so forth. Accordingly, transaction options information associated with transaction options that are more in line with specified preferences may be presented before other transaction options, or may be indicated in some manner as being more preferred.

At block 504, the service provider system 106 may receive an indication of a selection of a transaction option. For example, the requestor may be provided with functionality that allows the requestor to select a particular transaction option for processing of the requested financial transaction. In some embodiments, the client application may select a transaction option based on preference information that has been previously specified without receiving in-session input from the requestor. For example, the client application may execute pre-defined algorithms for determining a transaction option to select based on pre-specified preferences and may transmit an indication of the selected transaction option to the service provider system 106. The service provider system may further receive, on behalf of the requestor, additional transaction information at block 504 such as an indication of a transaction amount and, optionally, a desired transaction date.

Upon receipt of the indication of the selected transaction option and additional transaction information, the service provider system 106 may then proceed to initiate, at block 506, risk processing or transaction authorization processing, as appropriate, based on the source financial account and source payment network associated with the selected transaction option. The risk processing or transaction authorization processing may include, but is not limited to, credit account authorization processing, real-time debit processing, “good funds” processing, risk analysis with respect to the financial transaction, and so forth. The transaction amount and/or the transaction date may be factors that influence the outcome of the risk processing and/or the transaction authorization processing. The risk processing may be performed, for example, upon execution of computer-executable instructions provided as part of the risk processing module 222. The transaction authorization processing may be performed, for example, upon execution of computer-executable instructions provided as part of the transaction authorization processing module 224. In certain embodiments, risk processing or transaction authorization processing may be performed based on the target financial account, the target account holder, and/or the target payment network. A non-limiting example of such risk processing is payee risk management processing.

At block 508, a determination may be made as to whether the financial transaction is approved based on the risk processing or transaction authorization processing performed at block 506. If it is determined that the financial transaction is approved, the service provider system 106 may generate and transmit, potentially for presentation to the financial transaction requestor, an indication that the financial transaction has been approved. On the other hand, if it is determined, at block 508, that the financial transaction is not approved based on the risk processing or transaction authorization processing performed at block 506, an indication that the financial transaction has been declined may be generated and transmitted, potentially for presentation to the financial transaction requestor. The indication that the financial transaction has been approved and/or the indication that the financial transaction has been declined may be generated, for example, upon execution of computer-executable instructions provided as part of the notification generation module 226.

If the financial transaction has been approved for the selected transaction option, the client application via which the requestor may have submitted the financial transaction request may submit, at block 514, a request to the service provider system 106 to originate a debit and/or a credit associated with the financial transaction. In other embodiments, the service provider system 106 may originate the debit and/or credit independently of the client application if the risk processing or transaction authorization processing is successful. In still other embodiments, the service provider system 106 may have received a request to originate a debit and/or credit in association with the indication of the selected transaction option at block 504. In those embodiments in which the debit is originated upon receipt of the indication of the selected transaction option and the additional transaction information, the service provider system 106 may transmit, potentially for presentation to the requestor, an indication of successful posting of the debit at block 512 or an indication of failed posting of the debit at block 510. Alternatively, such as, for example, if the credit is to be posted to a target financial account that is accessible in real-time by a corresponding target payment network, the service provider system 106 may transmit, in lieu of an indication of the debit status alone, an indication of success of the financial transaction or an indication of the successful posting of the credit (at block 512) or an indication of failure of the financial transaction or an indication of the failed posting of the credit (at block 510) depending on whether the credit successfully posts to the target financial account or not. Origination of debit and/or credit instructions and transmission of the generated instructions to appropriate payment network(s) may be performed, for example, upon execution of computer-executable instructions provided as part of the payment networks hub module 220.

In the event that the financial transaction is declined as a result of failed risk processing or failed transaction authorization processing, a debit fails to post to the source financial account, or a credit fails to post to the target financial account, the requestor may be provided with the opportunity to select an alternative transaction option for the financial transaction. In certain embodiments, one or more of the transaction options initially presented to the requestor may no longer be available for selection based on the failure of the initially selected transaction option. Further, in various embodiments, one or more of the initially presented transaction options may be modified and the modified transaction option(s) may be presented to the requestor based on the failure of the initially selected transaction option. A fee associated with a transaction option may be modified to account for a greater amount of risk associated with the financial transaction. Alternatively, or additionally, a transaction limit and/or a timing characteristic associated with a transaction option may be modified. Selection of a modified transaction option by the requestor may then result in approval of the financial transaction.

At block 516, the service provider system 106 may receive an indication of a selection of an alternate transaction option. Upon receipt of the indication of the alternate transaction option, the service provider system 106 may proceed to perform risk processing or transaction authorization processing at block 506 and the process flow may continue as described earlier.

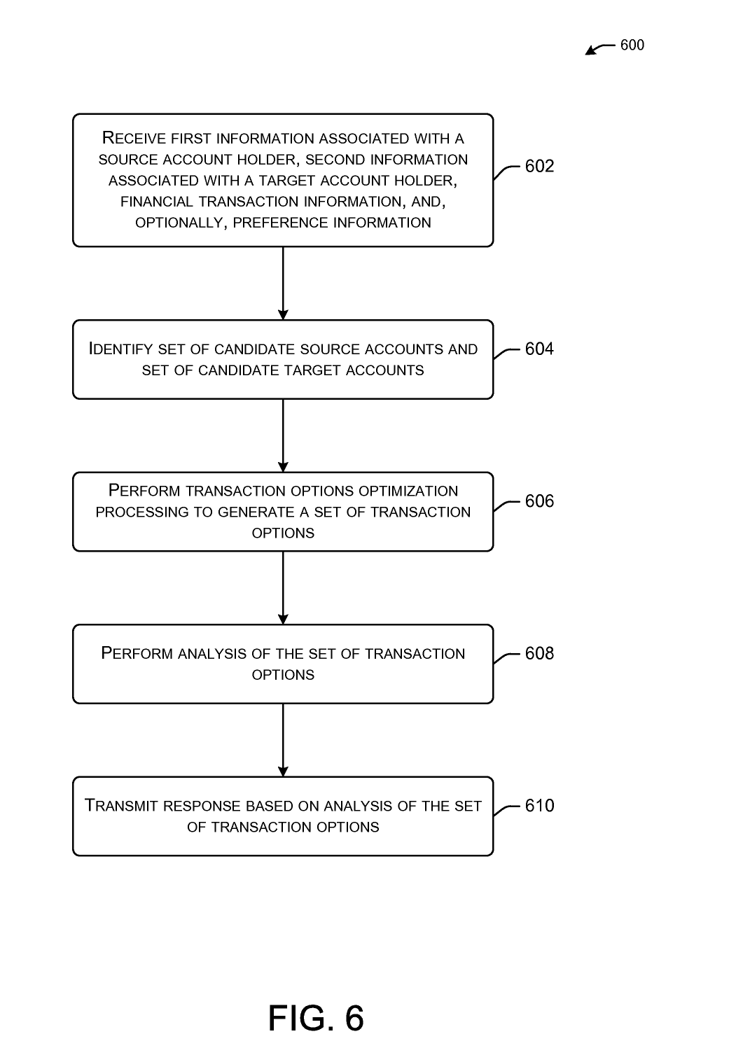

FIG. 6 is a process flow diagram depicting an illustrative method 600 for identifying candidate source and target financial accounts and associated candidate payment networks and performing transaction options optimization processing in accordance with one or more additional embodiments of the disclosure. The illustrative method 600 depicted in FIG. 6 may be performed in those embodiments in which a financial transaction request is received that includes a sufficient amount of information to execute the financial transaction.

At block 602, the service provider system 106 may receive, on behalf of a financial transaction requestor, a financial transaction request associated with a financial transaction. The request may include first information associated with a source account holder, second information associated with a target account holder, additional transaction information, and, optionally, preference information that indicates one or more preferences with respect to financial accounts, payment networks, transaction dates, and so forth. The additional transaction information that is received may include an indication of a funds amount associated with the financial transaction, and may further optionally include an indication of a desired transaction date. The transaction date may indicate a desired transaction posting date or a desired transaction issuance date. In certain embodiments, the preference information may indicate a preference for an “immediate/same-day” or “next day” transaction posting or issuance, in which case, a transaction date may not be explicitly provided. In certain embodiments, the financial transaction request may be received by the service provider system 106 from a client application via which the financial transaction requestor submits the financial transaction request.

Upon receipt of the financial transaction request, the service provider system 106 may, at block 604, identify a set of candidate source financial accounts and a set of candidate target financial accounts for the financial transaction request. The candidate source and target financial accounts may be identified in a similar manner as described earlier. More specifically, a source identifier and a target identifier may be identified from the first information and the second information, respectively, and registry information stored, for example, in the registry information datastore(s) 112A may be accessed to identify associated candidate source and target financial accounts.

Upon identification of the candidate source and target financial accounts, the service provider system 106 may perform transaction options optimization processing in a manner similar to that described earlier to generate a set of transaction options for the financial transaction. The service provider system 106 may, prior to initiating the transaction options optimization processing, perform risk analysis processing associated with one or more of the source account holder, target account holder, or the financial transaction requestor.

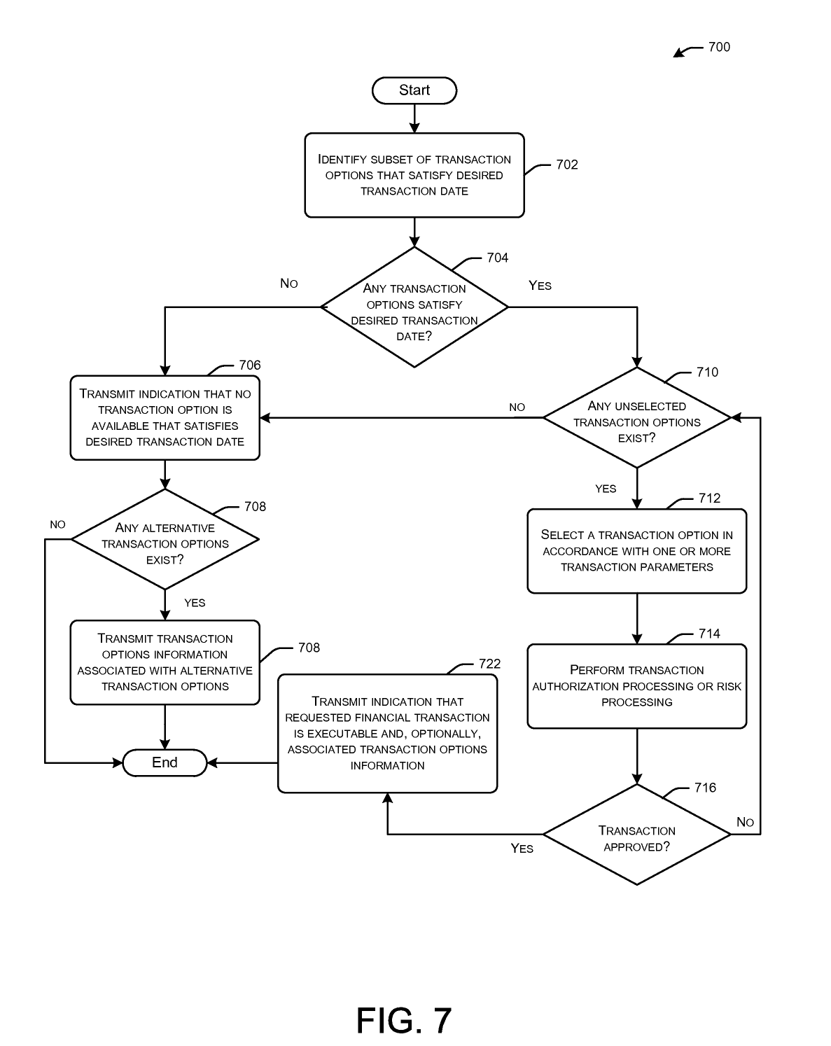

Upon generation of the set of transaction options, the service provider system 106 may perform an analysis of the set of transaction options at block 608 to determine if the financial transaction is executable in accordance with one or more of the transaction options. More specifically, an analysis may be performed to determine whether a transaction option exists that satisfies the desired transaction date and for which risk processing or transaction authorization processing is successful. The analysis performed at block 608 will be described in greater detail through reference to FIG. 7.

At block 610, the service provider system 106 may transmit a response based on the analysis performed at block 608, potentially for presentation to the requestor. In certain embodiments, the response may indicate whether the financial transaction is executable or not. In other embodiments, a variety of transaction options in accordance with which the financial transaction is executable may be presented to the financial transaction requestor, and the requestor may be provided with an opportunity to indicate a selection of one of the transaction options. In still other embodiments, if the financial transaction is determined not to be executable based on the specified financial transaction parameters (e.g., the funds amount, the desired transaction date, etc.), a set of one or more modified transaction options may be generated and transmitted, potentially for presentation to the requestor.

FIG. 7 is a process flow diagram depicting an illustrative method 700 for identifying whether a financial transaction is executable and transmitting information pertaining thereto in accordance with one or more embodiments of the disclosure.

At block 702, a subset of transaction options that satisfy a desired transaction date may be identified among the set of transaction options generated by the transaction options optimization processing. If no transaction date is specified in the financial transaction request, the service provider system 106 may generate a transaction date based at least in part on characteristics associated with one or more transaction options and/or based at least in part on default parameters. As noted earlier, each transaction option includes a combination of candidate source and target financial accounts and candidate source and target payment networks for which any associated account and network rules are satisfied. Accordingly, some transaction options may not be able to satisfy a desired transaction date (e.g., “immediate/same-day,” “next day,” etc.) based on the account rules associated with the source/target financial accounts and/or network rules associated with the source/target payment networks included in the transaction options. Accordingly, those transaction options capable of satisfying a desired transaction date are identified at block 702.

At block 704, a determination may be made as to whether any transaction options have been identified that are capable of satisfying the desired transaction date. If no such transaction options are identified, the method 700 may proceed to block 706 where an indication that no transaction option exists that satisfies the desired transaction date is generated and transmitted, potentially for presentation to the requestor. The indication transmitted at block 706 may be generated upon execution of computer-executable instructions provided as part of the notification generation module 226.

On the other hand, if it is determined that at least one transaction option has been identified that is capable of satisfying the desired transaction date, the method 700 may proceed to block 710 where a determination may be made as to whether any transaction options in the identified subset of transaction options have not been selected for further processing. Operations performed at blocks 710-716 may represent an iterative process in which the subset of transaction options satisfying the desired transaction date is iterated through until a transaction option for which the financial transaction is executable is identified or until all transaction options in the subset are processed. Accordingly, in a first iteration, a positive determination may be made at block 710 and the method 700 may proceed to block 712.

At block 712, a transaction option may be selected from the subset in accordance with one or more transaction parameters. More specifically, the transaction options included in the subset may be ordered or prioritized in accordance with one or more transaction parameters that may relate to, for example, a speed of the financial transaction, a cost of the financial transaction, an ability to determine or mitigate a risk of a failed posting of a debit, and so forth. For example, the transaction options included in the subset may be ordered such that those options capable of faster transaction speeds are given priority over those with slower transaction speeds. Alternatively, the transaction options may be ordered such that those options with lower associated fees are given priority over those with higher associated fees. In still other embodiments, the transaction options may be ordered such that those options capable of greater mitigation of risk (e.g., capable of supporting real-time debits) are given priority over those options with a lesser capability to mitigate risk (e.g., risk processing). In certain embodiments, a combination (e.g., a weighted combination) of one or more of the above transaction parameters may be used to order or prioritize the transaction options.

The transaction parameters based on which the transaction options may be ordered or prioritized may be specified by any number of entities including, but not limited to, a service provider associated with the service provider system 106, the financial transaction requestor, the source and/or target account holders, a sponsor, a financial institution, and so forth. In the event of the presence of a conflict between various transaction parameters used to order or prioritize transaction options, a means for conflict resolution (e.g., prioritization of entities specifying the transaction parameters) may be employed.

After the transaction options are ordered or prioritized based on one or more transaction parameters and an appropriate transaction option is selected, risk processing or transaction authorization processing may be performed at block 714. The risk processing or transaction authorization processing performed at block 714 may be similar to that described earlier.

At block 716, a determination may be made as to whether the financial transaction is executable in accordance with the selected transaction option based on results of the risk processing or transaction authorization processing. If it is determined that the financial transaction is executable in accordance with the selected transaction option, an indication that the requested financial transaction is executable may be generated and transmitted at block 722, potentially for presentation to the requestor. Optionally, additional information associated with the transaction option may be transmitted as well including, but not limited to, transaction characteristics such as a speed and/or cost of the financial transaction, source/target financial accounts to be used, source/target payment networks to be used, and so forth. In certain embodiments, a financial transaction requestor may be provided with an opportunity to indicate final approval of the financial transaction after being presented with the additional transaction information (e.g., fees). In other embodiments, the service provider system 106 may proceed with execution of the financial transaction if the risk processing or transaction authorization processing is successful without requiring further approval from the financial transaction requestor.

On the other hand, if it is determined at block 716 that the financial transaction is not executable in accordance with the selected transaction option based on failure of the risk processing or transaction authorization processing, the method 700 may again proceed to block 710 where a determination may be made as to whether any transaction options remain that have not been selected for further processing. If no such transaction option remains, the method 700 may proceed to block 706 where an indication that no transaction option exists that satisfies the desired transaction date is generated and transmitted, potentially for presentation to the requestor. If, however, unselected transaction options remain, the remaining unselected transaction options may be iterated through until a transaction option for which the financial transaction is executable is identified or until all transaction options in the subset are processed.

If the financial transaction is not executable in accordance with a transaction option that satisfies a desired transaction date, a determination may be made at block 708 as to whether any alternative transaction options exist for processing the financial transaction. Further transaction options optimization processing may be performed to determine whether any alternative transaction options exist. The alternate transaction options may be associated with one or more modified financial transaction parameters including, but not limited to, a modified transaction date, a modified funds amount, and so forth. If it is determined that no such alternative transaction options exist, the method 700 may end. Alternatively, if at least one alternative transaction option is determined to exist, transactions options information associated with the alternative transaction options may be transmitted, potentially for presentation to the requestor. The requestor may then be provided (not shown) with an opportunity to select a transaction option from among the alternative transaction options. Upon selection of an alternative transaction option, risk processing or transaction authorization processing may be performed in connection with the selected alternative transaction option, and the financial transaction may be executed if the risk processing or transaction authorization processing is successful. For each alternative transaction option, the transaction options information may include information that identifies a speed of the financial transaction in an abstracted form (as described earlier) and/or information that identifies associated fees. Optionally, additional transaction details may be transmitted as well as described earlier.

In the illustrative method 700, iteration through the subset of transaction options satisfying the desired transaction date is halted upon identification of a transaction option in accordance with which the financial transaction is executable. However, in other alternative embodiments, the entire subset of transaction options may be iterated through to identify each transaction option for which the financial transaction is executable. Each such transaction option may be flagged and associated transaction options information may be transmitted, potentially for presentation to the requestor. The requestor may be provided with an opportunity to select a desired transaction option. Transmitting information associated with multiple transaction options for which the requested financial transaction is executable may be desirable if, for example, different speeds and/or fees are associated with each transaction option, in which case, the requestor is provided with an opportunity to select the most desirable transaction option.

In one or more embodiments, a client application via which transaction options information is presented to a requestor and via which the requestor may indicate a selection of a transaction option may form part of the service provider system 106. Accordingly, any functionality described herein as being performed by a client application may, in various embodiments, be performed by the service provider system 106 upon, for example, execution of computer-executable instructions provided as part of the client application(s) module 228.

Further, while certain illustrative methods have been depicted and described, it should be appreciated that numerous other modifications, alternatives, and so forth to various processing flows are within the scope of this disclosure. For example, in various embodiments, one or more of the processing steps described herein may not be present and/or additional processing steps may be present.

### Illustrative Use Cases

FIG. 8 is a schematic diagram depicting an illustrative use case in accordance with one or more embodiments of the disclosure. A financial transaction requestor may utilize a user device 802 to access functionality that may be provided by a client application. An illustrative user interface 804 may be provided via which a requestor may submit a financial transaction request. The user interface 804 may be associated with the client application which may, in certain embodiments, form part of the service provider system 106. Respective fields 806, 808 may be provided for inputting (or selecting from pre-populated entries) a source identifier and a target identifier associated with a financial transaction request. Although not depicted, the user interface 804 may also provide a requestor with a capability to specify one or more preferences associated with the financial transaction request. Alternatively, or additionally, any such preferences may already be known to the client application. A selectable widget 810 may be provided for submitting the financial transaction request. The illustrative use case depicted in FIG. 8 may correspond to those embodiments in which a complete financial transaction request is not received (e.g., a transaction amount is not received).

Upon receipt of the financial transaction request, the service provider system 106 may proceed to identify candidate source and candidate target financial accounts, identify candidate source and candidate target payment networks, and perform transaction options optimization processing 812 to generate a set of transaction options. Transaction options information associated with the generated set of transaction options may be generated and transmitted for presentation to the requestor. Illustrative transaction options 814 are shown in FIG. 8. A high funds transfer amount transaction option is illustratively shown among the transaction options 814. As described previously, the transaction options information may include information presented in an abstracted form that relates to a speed of the financial transaction. The transaction options information may further indicate a respective fee associated with each transaction option. A field 816 may also be provided for a requestor to indicate a funds amount associated with the financial transaction.

The requestor may indicate a selection of one of the transaction options via any suitable mechanism provided by the user interface, identify a funds amount, and use a selectable widget 818 to initiate transmission of an indication of the selected transaction option and the funds amount to the service provider system 106. The service provider system 106 may receive the indication of the selected transaction option and the funds amount and perform risk processing or transaction authorization processing to determine whether the financial transaction is approved or declined. If the financial transaction is approved in accordance with the selected transaction option, the service provider system 106 may proceed to originate a debit and/or credit associated with the financial transaction. Information 822 indicating success of the financial transaction (or successful posting of a debit) may be transmitted for presentation to the requestor. In one or more alternative embodiments, if the financial transaction is approved, an indication of the approval may be transmitted, potentially for presentation to the requestor, at which point, a request to originate a debit and/or credit associated with the financial transaction may be received from the client application.

In other embodiments, if the financial transaction is declined, information indicating that the transaction has been declined may be transmitted, potentially for presentation to the requestor. In those embodiments in which the service provider system has proceeded to originate the debit and/or credit, an indication of failed posting of the debit or failure of the transaction may be transmitted and potentially presented to the requestor. In the case of a decline of the financial transaction (or failed posting of a debit or failure of the financial transaction), the requestor may be provided with a capability to select an alternative transaction option. In certain embodiments, failure to execute the financial transaction in accordance with the initially selected transaction option may result in elimination of one or more other transaction options that were initially presented to the requestor. For example, the initially selected transaction option may have failed as a result of good funds processing. As such, a “high funds amount” transaction option that was previously presented may be eliminated and a funds amount limit may become associated with the remaining alternative transaction options. As another non-limiting example, if the financial transaction is disapproved for the initially selected transaction option (e.g., as a result of failed good funds processing), timing characteristics associated with the transaction options may be modified, another financial account for completing the financial transaction may be considered, and so forth. For example, delayed processing (e.g., some future transaction date as opposed to “immediate” or “next-day”) may be considered to mitigate risk associated with the financial transaction. Alternatively, a different financial account (e.g., a card account rather than a DDA, a different DDA, etc.) may be considered, potentially with the same timing characteristics as the initially selected transaction option. It should be appreciated that the above examples of ways in which the transaction options may be modified are illustrative and not exhaustive. The requestor may indicate a selection of an alternative transaction option and submit the modified financial transaction request to the service provider system 106 via a selectable widget 826.

FIG. 9 is a schematic diagram depicting another illustrative use case 900 in accordance with one or more additional embodiments of the disclosure. A financial transaction requestor may utilize a user device 902 to access functionality that may be provided by a client application. An illustrative user interface 904 may be provided via which a requestor may submit a financial transaction request. The user interface 904 may be associated with the client application which may, in various embodiments, form part of the service provider system 106. Respective fields 904A, 904B may be provided for inputting (or selecting from pre-populated entries) a source identifier and a target identifier associated with a financial transaction request. Further, a field 904C may be provided for inputting a funds amount associated with the financial transaction. In addition, a desired transaction date may optionally be specified (e.g., selected from pre-defined entries) in field 904D. Although not depicted, the user interface 904 may also provide a requestor with a capability to specify one or more preferences associated with the financial transaction request. Alternatively, or additionally, any such preferences may already be known to the client application. A means (not shown) for submitting the financial transaction request may also be provided. The illustrative use case depicted in FIG. 9 may correspond to those embodiments in which a complete financial transaction request is received (e.g., a transaction amount and, optionally, a transaction date is received).

Upon receipt of the financial transaction request, the service provider system 106 may proceed to identify candidate source and candidate target financial accounts, identify candidate source and candidate target payment networks, and perform transaction options optimization processing 906 to generate a set of transaction options. Upon generation of the set of transaction options, the service provider system may perform an analysis 908 of the set of transaction options to determine if the financial transaction is executable in accordance with any transaction option that is capable of satisfying a requested or determined transaction date.

In one or more embodiments, a transaction option may be identified in accordance with which the requested financial transaction is executable. In such embodiments, information 910 associated with the identified transaction option may be transmitted and potentially presented to the requestor. In this manner, the requestor may be provided with a capability to indicate final approval of the transaction upon receiving information regarding any fees associated with the identified transaction option. A means for initiating transmission of the approval to the service provider system 106 (e.g., a selectable widget 912) may be provided.

In one or more alternative embodiments, all transaction options included in a subset of transaction options satisfying a desired transaction date may be iterated through to identify each transaction option in connection with which the financial transaction is capable of being executed. Transaction options information 918 associated with each such transaction option that is identified may be transmitted and potentially presented to the requestor. In this manner, the requestor may obtain information regarding respective fees associated with each transaction option and indicate a selection of a desired transaction option. For example, each transaction option may have an associated respective timing characteristic that satisfies the requested transaction date (e.g., “same-day”). However, the transaction options may have different respective fees associated therewith based, for example, on different funding accounts and different associated levels of risk. For example, one transaction option may include a DDA as the source financial account, another may include a debit card as the source financial account, yet another may include a credit card as the source financial account, and so forth. A means for initiating transmission of an indication of the selected transaction option to the service provider system 106 (e.g., a selectable widget 920) may be provided.

In certain embodiments, no transaction option may exist that is capable of satisfying a desired transaction date. In such embodiments, one or more alternative transaction options may be identified and transaction options information 914 relating thereto may be transmitted, potentially for presentation to the requestor. The requestor may then indicate a selection of one of the alternative transaction options. A means for initiating transmission of an indication of the selected alternative transaction option to the service provider system 106 (e.g., a selectable widget 916) may be provided.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, although specific example embodiments have been presented, it should be appreciated that numerous other examples are within the scope of this disclosure.

Additional types of CRSM that may be present in association with any of the components described herein (e.g., any of the components of the networked architecture 100) may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, solid-state memory devices, or any other medium. Combinations of any of the above are also included within the scope of CRSM.

Alternatively, computer-readable communication media may include computer-readable instructions, program modules, or other data transmitted within a data signal, such as a carrier wave, or other transmission. However, as used herein, CRSM does not include computer-readable communication media. Examples of computer-readable communication media, whether modulated using a carrier or not, include, but are not limited to, signals that a computer system or machine hosting or running a computer program can be configured to access, including signals downloaded through the Internet or other networks. For example, the distribution of software may be an Internet download.

Although embodiments have been described in language specific to structural features and/or methodological acts, it is to be understood that the disclosure is not necessarily limited to the specific features or acts described. Rather, the specific features and acts are disclosed as illustrative forms of embodiments of the disclosure. Conditional language such as, for example, “can,” “could,” “might,” or “may,” unless specifically stated otherwise, or unless otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A system, comprising:
one or more computers comprising:
at least one memory storing computer-executable instructions; and
at least one processor configured to access the at least one memory and to execute the computer-executable instructions to:
receive i) first information associated with a first account holder and ii) second information associated with a second account holder;
identify, based at least in part on the first information, i) one or more candidate source financial accounts and ii) a respective one or more candidate source payment networks associated with each candidate source financial account;
identify, based at least in part on the second information, i) one or more candidate target financial accounts and ii) a respective one or more candidate target payment networks associated with each candidate target financial account;
generate, based at least in part on an analysis of one or more rules, a set of transaction options, wherein the set of transaction options comprises a first transaction option and a second transaction option, and wherein a first set of one or more transaction characteristics is associated with the first transaction option and a second set of one or more transaction characteristics is associated with the second transaction option; and
transmit transaction options information associated with the set of transaction options, wherein the transactions options information comprises: i) information associated with the first set of one or more transaction characteristics, and ii) information associated with the second set of one or more transaction characteristics.

2. The system of claim 1, wherein the first transaction option is further associated with:
i) a first candidate source financial account,
ii) a first candidate source payment network,
iii) a first candidate target financial account, and
iv) a first candidate target payment network; and
the second transaction option is further associated with:
i) a second candidate source financial account,
ii) a second candidate source payment network,
iii) a second candidate target financial account, and
iv) a second candidate target payment network.

3. The system of claim 2, wherein at least one of:
i) the first candidate source financial account and the second candidate source financial account are a same financial account,
ii) the first candidate source payment network and the second candidate source payment network are a same payment network,
iii) the first candidate target financial account and the second candidate target financial account are a same financial account,
iv) the first candidate target payment network and the second candidate target payment network are a same payment network, or
v) a transaction characteristic included in the first set of one or more transaction characteristics and a transaction characteristic included in the second set of one or more transaction characteristics is a same transaction characteristic.

4. The system of claim 2, wherein the transaction options information further comprises:
at least one of:
i) information indicating the first candidate source financial account,
ii) information indicating the first candidate source payment network,
iii) information indicating the first candidate target financial account, or
iv) information indicating the first candidate target payment network; and
at least one of:
i) information indicating the second candidate source financial account,
ii) information indicating the second candidate source payment network,
iii) information indicating the second candidate target financial account, or
iv) information indicating the second candidate target payment network.

5. The system of claim 1, wherein each of the one or more rules is associated with at least one of:
i) a payment network,
ii) a financial account,
iii) a type of financial account,
iii) the first account holder,
iv) the second account holder,
v) a requestor of a financial transaction,
vi) a financial institution associated with one of the one or more candidate source financial accounts or one of the one or more candidate target financial accounts,
vi) a sponsor of one of the first account holder, the second account holder, or the requestor, or
vii) a service provider.

6. The system of claim 1, wherein each of: i) the information associated with the first set of one or more transaction characteristics and ii) the information associated with the second set of one or more transaction characteristics comprises a respective at least one of: i) an indication of transaction cost or ii) an indication of transaction speed.

7. The system of claim 1, wherein the at least one processor is configured to execute the computer-executable instructions to transmit the transaction options information for presentation to a requestor of a financial transaction.

8. The system of claim 7, wherein the at least one processor is further configured to execute the computer-executable instructions to:
receive, on behalf of the requestor, a financial transaction request associated with a financial transaction, wherein the financial transaction request comprises i) an indication of a selection of a selected transaction option and ii) an indication of a transaction amount, and wherein the selected transaction option comprises one of: i) the first transaction option or ii) the second transaction option.

9. The system of claim 8, wherein the financial transaction is associated with one of:
(i) a bill payment,
(ii) a person-to-person payment,
(iii) a retail payment,
(iv) an account-to-account transfer,
(v) a financial account opening, or
(vi) a check deposit.

10. The system of claim 8, wherein the selection of the selected transaction option is based at least in part on one or more pre-specified preferences associated with one of: i) the first account holder, ii) the second account holder, or iii) the requestor.

11. The system of claim 8, wherein the financial transaction request further comprises an indication of a desired transaction date.

12. The system of claim 8, wherein the at least one processor is further configured to execute the computer-executable instructions to:
perform risk processing or transaction authorization processing based at least in part on the financial transaction request; and
determine, based at least in part on the risk processing or the transaction authorization processing, that the financial transaction is i) approved or ii) declined.

13. The system of claim 12, wherein the at least one processor is further configured to execute the computer-executable instructions to:
transmit, for presentation to the requestor and based at least in part on the determining, one of: i) an indication that the financial transaction is approved or ii) an indication that the financial transaction is declined.

14. The system of claim 13, wherein it is determined that the financial transaction is declined, wherein the indication that the financial transaction is declined is transmitted for presentation to the requestor, and wherein the at least one processor is further configured to execute the computer-executable instructions to:
identify one or more modified transaction options; and
transmit, for presentation to the requestor, information associated with the one or more modified transaction options.

15. The system of claim 12, wherein it is determined that the financial transaction request is approved, and wherein the at least one processor is further configured to execute the computer-executable instructions to:
perform, based at least in part on the selected transaction option, processing to originate a debit from a source financial account associated with the selected transaction option via a source payment network associated with the source financial account.

16. The system of claim 15, wherein the at least one processor is further configured to execute the computer-executable instructions to:
transmit, for presentation to the requestor, an indication of one of: i) successful posting of the debit or ii) failed posting of the debit.

17. The system of claim 12, wherein it is determined that the financial transaction request is approved, and wherein the at least one processor is further configured to execute the computer-executable instructions to:
perform, based at least in part on the selected transaction option, processing to originate a credit to a target financial account associated with the selected transaction option via a target payment network associated with the target financial account.

18. The system of claim 17, wherein the at least one processor is further configured to execute the computer-executable instructions to:
transmit, for presentation to the requestor, an indication of one of: i) successful posting of the credit, ii) failed posting of the credit, iii) success of the financial transaction, or iv) failure of the financial transaction.

19. The system of claim 1, wherein the first information comprises a source identifier associated with the first account holder and the second information comprises a target identifier associated with the second account holder.

20. The system of claim 19, wherein each of the source identifier or the target identifier comprises a respective one of:
(i) an electronic mail address,
(ii) a telephone number,
(iii) a social network identifier,
(iv) a financial account identifier, or
(v) an entity identifier.

21. The system of claim 20, wherein one of: (i) the source identifier or (ii) the target identifier comprises the respective financial account identifier, and wherein the respective financial account identifier is associated with one of: (i) a card account or (ii) a demand deposit account.

22. The system of claim 21, wherein the respective financial account identifier is not associated with either of (i) the one or more candidate source financial accounts or (ii) the one or more candidate target financial accounts.

23. The system of claim 20, wherein one of: i) the source identifier or ii) the target identifier comprises the respective entity identifier, and wherein the respective entity identifier comprises one of:
(i) a username associated with a service provider,
(ii) a username associated with a financial institution,
(iii) a government identifier,
(iv) an identifier associated with a payee or an identifier associated with a payor, or
(v) an identifier designated by a financial transaction requestor for identifying a payor or a payee.

24. The system of claim 1, wherein each of the one or more candidate source financial accounts and each of the one or more candidate target financial accounts comprises a respective one of:
(i) a demand deposit account,
(ii) a savings account,
(iii) a money market account,
(iv) a line of credit account,
(v) a debit card account,
(vi) a credit card account,
(vii) a prepaid card account,
(viii) a stored value account, or
(ix) a brokerage account.

25. The system of claim 1, wherein each of the respective one or more candidate source payment networks and each of the respective one or more candidate target payment networks comprises a respective one of: (i) an Automated Clearinghouse (ACH) network, ii) a real-time network of financial institutions, (iii) a debit network, or (iv) a credit network.

26. A method, comprising:
receiving, by a service provider system comprising one or more computers, i) first information associated with a first account holder and ii) second information associated with a second account holder;
identifying, by the service provider system and based at least in part on the first information, i) one or more candidate source financial accounts and ii) a respective one or more candidate source payment networks associated with each candidate source financial account;
identifying, by the service provider system and based at least in part on the second information, i) one or more candidate target financial accounts and ii) a respective one or more candidate target payment networks associated with each candidate target financial account;
generating, by the service provider system and based at least in part on an analysis of one or more rules, a set of transaction options, wherein the set of transaction options comprises a first transaction option and a second transaction option, and wherein a first set of one or more transaction characteristics is associated with the first transaction option and a second set of one or more transaction characteristics is associated with the second transaction option; and
transmitting, by the service provider system, transaction options information associated with the set of transaction options, wherein the transactions options information comprises: i) information associated with the first set of one or more transaction characteristics, and ii) information associated with the second set of one or more transaction characteristics.

27. The method of claim 26, wherein the first transaction option is further associated with:
i) a first candidate source financial account,
ii) a first candidate source payment network,
iii) a first candidate target financial account, and
iv) a first candidate target payment network; and
the second transaction option is further associated with:
i) a second candidate source financial account,
ii) a second candidate source payment network,
iii) a second candidate target financial account, and
iv) a second candidate target payment network.

28. The method of claim 26, wherein each of the one or more rules is associated with at least one of:
i) a payment network,
ii) a financial account,
iii) a type of financial account,
iii) the first account holder,
iv) the second account holder,
v) a requestor of a financial transaction,
vi) a financial institution associated with one of the one or more candidate source financial accounts or one of the one or more candidate target financial accounts,
vi) a sponsor of one of the first account holder, the second account holder, or the requestor, or
vii) the service provider system.

29. The method of claim 26, wherein each of: i) the information associated with the first set of one or more transaction characteristics and ii) the information associated with the second set of one or more transaction characteristics comprises a respective at least one of: i) an indication of transaction cost or ii) an indication of transaction speed.

30. The method of claim 26, wherein transmitting the transaction options information comprises transmitting the transaction options information for presentation to a requestor of a financial transaction.

31. The method of claim 30, further comprising:
receiving, by the service provider system on behalf of the requestor, a financial transaction request associated with a financial transaction, wherein the financial transaction request comprises i) an indication of a selection of a selected transaction option and ii) an indication of a transaction amount, and wherein the selected transaction option comprises one of: i) the first transaction option or ii) the second transaction option.

32. The method of claim 31, further comprising:
performing, by the service provider system, risk processing or transaction authorization processing based at least in part on the financial transaction request; and
determining, by the service provider system and based at least in part on the risk processing or the transaction authorization processing, that the financial transaction is i) approved or ii) declined.

33. The method of claim 32, further comprising:
transmitting, by the service provider system and based at least in part on the determining, one of: i) an indication that the financial transaction is approved or ii) an indication that the financial transaction is declined.

34. The method of claim 33, wherein it is determined that the financial transaction is declined and the indication that the financial transaction is declined is transmitted for presentation to the requestor, further comprising:
identifying, by the service provider system, one or more modified transaction options; and
transmitting, by the service provider system for presentation to the requestor, information associated with the one or more modified transaction options.

35. The method of claim 26, wherein the first information comprises a source identifier associated with the first account holder and the second information comprises a target identifier associated with the second account holder.

36. The method of claim 26, wherein each of the one or more candidate source financial accounts and each of the one or more candidate target financial accounts comprises a respective one of:
(i) a demand deposit account,
(ii) a savings account,
(iii) a money market account,
(iv) a line of credit account,
(v) a debit card account,
(vi) a credit card account,
(vii) a prepaid card account,
(viii) a stored value account, or
(ix) a brokerage account.

37. The method of claim 26, wherein each of the respective one or more candidate source payment networks and each of the respective one or more candidate target payment networks comprises a respective one of: (i) an Automated Clearinghouse (ACH) network, ii) a real-time network of financial institutions, (iii) a debit network, or (iv) a credit network.

38. A system, comprising:
one or more computers comprising:
at least one memory storing computer-executable instructions; and
at least one processor configured to access the at least one memory and to execute the computer-executable instructions to:
receive, on behalf of a requestor, a request associated with a financial transaction, wherein the request comprises: i) first information associated with a first account holder, ii) second information associated with a second account holder, and iii) third information comprising an indication of a funds amount associated with the financial transaction;
identify, based at least in part on the first information, i) one or more candidate source financial accounts and ii) a respective one or more source payment networks associated with each candidate source financial account;
identify, based at least in part on the second information, i) one or more candidate target financial accounts and ii) a respective one or more target payment networks associated with each candidate target financial account;
identify, based at least in part on an analysis of one or more rules, one or more transaction options, wherein each transaction option is associated with a respective candidate source financial account, a respective source payment network, a respective target financial account, and a respective target payment network;
analyze the one or more transaction options;
generate a response to the request based at least in part on the analyzing, wherein the response comprises one of: i) an indication that the financial transaction is executable or ii) an indication that the financial transaction is not executable; and
transmit, for presentation to the requestor, the response.

39. The system of claim 38, wherein each transaction option is further associated with a respective set of one or more transaction characteristics, and wherein each transaction characteristic is associated with one of: i) a speed associated with the financial transaction or ii) a cost associated with the financial transaction.

40. The system of claim 38, wherein the at least one processor is further configured to execute the computer-executable instructions to:
determine a transaction date associated with the financial transaction based at least in part on the request, or
receive, on behalf of the requestor, fourth information comprising an indication of a transaction date.

41. The system of claim 40, wherein the at least one processor is configured to execute the computer-executable instructions to analyze the one or more transaction options to one of:
determine that at least one transaction option of the one or more transaction options satisfies the transaction date, or
determine that none of the one or more transaction options satisfies the transaction date.

42. The system of claim 41, wherein it is determined that none of the one or more transaction options satisfies the transaction date, wherein the response comprises the indication that the financial transaction is not executable, and wherein the at least one processor is further configured to execute the computer-executable instructions to:
identify an alternative transaction option associated with a modified financial transaction, wherein the alternative transaction option is associated with at least one of: i) a modified funds amount or ii) a modified transaction date.

43. The system of claim 42, wherein the at least one processor is further configured to execute the computer-executable instructions to:
transmit, for presentation to the requestor, first information associated with the alternative transaction option, wherein the first information associated with the alternative transaction option comprises at least one of: i) an indication of the modified funds amount, ii) an indication of the modified transaction date, or iii) a fee associated with the modified financial transaction.

44. The system of claim 43, wherein the at least one processor is further configured to execute the computer-executable instructions to:
transmit second information associated with the alternative transaction option, wherein the second information associated with the alternative transaction option comprises at least one of: i) a source financial account, ii) a source payment network, iii) a target financial account, or iv) a target payment network.

45. The system of claim 41, wherein it is determined that the at least one transaction option satisfies the transaction date, and wherein the at least one processor is further configured to execute the computer-executable instructions to:
perform, for each of one or more of the at least one transaction option that satisfies the transaction date, a respective one of: i) transaction authorization processing or ii) risk processing; and
determine, based at least in part on the respective one of: i) the transaction authorization processing or ii) the risk processing, that the financial transaction is executable in accordance with one transaction option.

46. The system of claim 45, wherein the response comprises the indication that the financial transaction is executable and further comprises information associated with the one transaction option, wherein the information comprises at least one of: i) a fee, ii) a source financial account, iii) a source payment network, iv) a target financial account, or v) a target payment network.

47. The system of claim 46, wherein the at least one processor is further configured to execute the computer-executable instructions to:
receive, on behalf of the requestor, at least one of: i) a request to originate a debit from the source financial account or ii) a request to originate a credit to the target financial account.

48. The system of claim 46, wherein the at least one processor is further configured to execute the computer-executable instructions to:
originate a debit from the source financial account; and
originate a credit to the target financial account.

49. A method, comprising:
receiving, by a service provider system comprising one or more computers and on behalf of a requestor, a request associated with a financial transaction, wherein the request comprises: i) first information associated with a first account holder, ii) second information associated with a second account holder, and iii) third information comprising an indication of a funds amount associated with the financial transaction;
identifying, by the service provider system and based at least in part on the first information, i) one or more candidate source financial accounts and ii) a respective one or more source payment networks associated with each candidate source financial account;
identifying, by the service provider system and based at least in part on the second information, i) one or more candidate target financial accounts and ii) a respective one or more target payment networks associated with each candidate target financial account;
identifying, by the service provider system and based at least in part on an analysis of one or more rules, one or more transaction options, wherein each transaction option is associated with a respective candidate source financial account, a respective source payment network, a respective target financial account, and a respective target payment network;
analyzing, by the service provider system, the one or more transaction options;
generating, by the service provider system, a response to the request based at least in part on the analyzing, wherein the response comprises one of: i) an indication that the financial transaction is executable or ii) an indication that the financial transaction is not executable; and
transmitting, by the service provider system for presentation to the requestor, the response.

50. The method of claim 49, wherein each transaction option is further associated with a respective set of one or more transaction characteristics, and wherein each transaction characteristic is associated with one of: i) a speed associated with the financial transaction or ii) a cost associated with the financial transaction.

51. The method of claim 49, further comprising one of:
determining, by the service provider system, a transaction date associated with the financial transaction based at least in part on the request, or
receiving, by the service provider system on behalf of the requestor, fourth information comprising an indication of a transaction date.

52. The method of claim 51, wherein the analyzing the one or more transaction options comprises one of:
determining, by the service provider system, that at least one transaction option of the one or more transaction options satisfies the transaction date, or
determining, by the service provider system, that none of the one or more transaction options satisfies the transaction date.

53. The method of claim 52, wherein it is determined that none of the one or more transaction options satisfies the transaction date, and wherein the response comprises the indication that the financial transaction is not executable, further comprising:
identifying, by the service provider system, an alternative transaction option associated with a modified financial transaction, wherein the alternative transaction option is associated with at least one of: i) a modified funds amount or ii) a modified transaction date.

54. The method of claim 53, further comprising:
transmitting, by the service provider system for presentation to the requestor, first information associated with the alternative transaction option, wherein the first information associated with the alternative transaction option comprises at least one of: i) an indication of the modified funds amount, ii) an indication of the modified transaction date, or iii) a fee associated with the modified financial transaction.

55. The method of claim 52, wherein it is determined that the at least one transaction option satisfies the transaction date, further comprising:
performing, by the service provider system for each of one or more of the at least one transaction option that satisfies the transaction date, a respective one of: i) transaction authorization processing or ii) risk processing; and
determining, by the service provider system and based at least in part on the respective one of: i) the transaction authorization processing or ii) the risk processing, that the financial transaction is executable in accordance with one transaction option.

56. The method of claim 55, wherein the response comprises the indication that the financial transaction is executable and further comprises information associated with the one transaction option, wherein the information comprises at least one of: i) a fee, ii) a source financial account, iii) a source payment network, iv) a target financial account, or v) a target payment network.
